(19) United States
(12) Patent Application Publication
(10) Pub. No.: US 2026/0365812 A1
(43) Pub. Date: Nov. 19, 2026

(54) METHOD FOR RECYCLING WASTE BASED ON PVC PLASTICS IMPLEMENTING A DEVICE FOR EXTRACTING POLYMER CHAINS IN A SIZE-EXCLUSION SIMULATED MOVING BED

(71) Applicant: IFP Energies Nouvelles, Rueil-Malmaison (FR)

(72) Inventors: Damien LEINEKUGEL LE COCQ, Rueil-Malmaison Cedex (FR); Mathilde SIBEAUD, Rueil-Malmaison Cedex (FR); Alexandra CHAUMONNOT, Rueil-Malmaison Cedex (FR); Alexandra BERLIOZ-BARBIER, Rueil-Malmaison Cedex (FR); Guillaume BLANCKE, Rueil-Malmaison Cedex (FR); Marc JACQUIN, Rueil-Malmaison Cedex (FR)

(73) Assignee: IFP Energies Nouvelles, Rueil-Malmaison (FR)

(21) Appl. No.: 19/133,553

(22) PCT Filed: Nov. 23, 2023
(86) PCT No.: PCT/EP2023/082787

§ 371 Date: May 28, 2025

(30) Foreign Application Priority Data
Dec. 1, 2022 (FR) FR2212608

(51) Int. Cl. C08J 11/08; C08F 14/06

(52) U.S. Cl. CPC C08J 11/08; C08F 14/06; C08J 2327/06

(57) ABSTRACT

A process for the recovery of a stream of PVC, comprises:
a) a dissolution stage wherein a plastic feedstock is brought into contact with a dissolution solvent; then
(b) an extraction stage by implementing fixed beds of a size exclusion solid in series and fed with polymer solution resulting from (a) at an injection point (F) and with an eluent at an injection point (S), and implementing withdrawal of an extract at a withdrawal point (E) and withdrawal of a raffinate comprising a purified polymer solution at a withdrawal point (R), the injection and withdrawal points being distinct and shifted over time by one bed according to a predetermined frequency; and then
(c) a stage of polymer-solvent separation, in order to obtain a stream of purified PVC.

Also described herein is a device for carrying out the recovery process and a device for carrying out stage b).

### TECHNICAL FIELD

The invention relates to the field of the recycling of plastics based on poly(vinyl chloride) (PVC), in particular to a process for the treatment of a plastic feedstock resulting from PVC-based plastic waste in order to obtain a stream of at least one purified PVC polymer making possible its reuse in the manufacture of new plastic objects. More precisely, the invention relates to a process for the treatment of a plastic feedstock, in particular resulting from PVC-based plastic waste, comprising the dissolution of at least one PVC polymer in a solvent, at least one stage of purification of the polymer solution thus obtained and the separation of at least one PVC polymer and of at least one solvent in order to recover a stream of at least one purified PVC polymer for subsequent upgrading.

### PRIOR ART

By definition, a plastic is a mixture consisting of a base polymeric material and of numerous additives, the assembly being capable of being moulded or fashioned (generally under hot conditions and/or under pressure), in order to result in a semi-finished product or in an object. A commonly accepted practice is to name said plastic by the name of the polymer of which it is made. Thus, the plastic poly(vinyl chloride) (PVC) corresponds in fact to the combination of the PVC polymer, sometimes denoted “PVC resin” in the continuation of the description, with various additives chosen as a function of the functionalities required for said plastic. Said additives can be organic (macro)molecules or else inorganic (nano)particles and are used as a function of the properties desired for the PVC plastic: resistance to heat, to light or to a mechanical stress, flexibility, processability, colouration and the like.

Several methods for recycling PVC plastics exist: “conventional” methods by simple mechanical recycling of the plastics, methods involving modifications to their composition (with optionally chemical transformations of the starting constituents) and the like.

Since the middle of the 20^{th} century, the recycling of PVC plastic involving a physical process has formed the subject of numerous studies targeted, in a first stage, at dissolving the PVC resin with a variable proportion of additives and then, in a second stage, at recovering said resin according to various processes (precipitation, evaporation, and the like) in the presence of all or some of the soluble additives. For example, mention is made of the patents EP 0 945 481 and EP 1 268 628, on the one hand, and EP 2 276 801, on the other hand, which are targeted at recycling respectively various PVC-based objects (flexible or rigid pipes, window frames, cables, and the like) and specifically fibre-reinforced PVC-based objects (tarpaulins, floor coverings, and the like) according to a process employing a stage of dissolution in an organic solvent of the PVC resin and of the soluble additives, followed by a stage of steam precipitation making possible the recovery of the PVC resin and of the majority of the additives.

However, it is not always desirable to keep said additives within the PVC thus recovered to be recycled. For example, the change over time in the regulations which concern them is impactful. Thus, some plasticizers belonging to the family of the phthalates, which were in particular widely used to formulate “flexible” PVCs about 40 years ago, progressively became subject to authorization in Europe on the basis of the REACH regulation, which since the end of 2006 has been targeted at rendering safe the manufacture and the use of chemical substances in European industry, and finally were progressively excluded from the additives permitted for use (Annexes XIV and XVII of Regulation (EC) No. 1907/2006 of the European Parliament and of the Council of 18 Dec. 2006). Following the same trend, the use of Cd-based metal stabilizers in PVC plastic formulations referred to in particular as PVC compounds (in particular “rigid” PVC plastics) was prohibited by an amendment to said Annex XVII (Regulation 494/2011 of 20 May 2011). Similarly, lead-based stabilizers were subject to restrictions (Annex XV) which were described in detail and adopted between December 2017 and March 2018 by the Risk Assessment Committee (RAC) and Socio-Economic Analysis Committee (SEAC) of the ECHA. Thus, during the last 20 years, several families of additives have seen their field of use become restricted; there is a strong risk of this phenomenon becoming magnified in the coming years.

These new regulations have today resulted in the prohibition of the presence of many additives in recycled starting materials (RSM), via in particular the establishment of limiting thresholds in terms of authorized amounts which are very restricting (for example, the amount of phthalates subject to authorization and considered as a mixture must not exceed more than 1000 ppm of the final composition of the RSM concerned). Taking into account the often very long lifetime of PVC-based objects (several decades), PVC-based objects formulated before the end of 2006 and now at the end of their life cannot be recycled via regeneration methods resulting in the maintenance of these prohibited additives, whether said methods are conventional, such as mechanical recycling processes, or non-conventional, such as the examples of processes by dissolution/precipitation mentioned above.

In view, on the one hand, of the current and future regulatory constraints and, on the other hand, of the limitation of fossil resources which highlights the need to move towards a “circular” economy, to produce a purified polymeric resin (i.e. devoid as much as possible of additives) from plastic waste for reuse as RSM equivalent to a virgin resin resulting from petroleum is today a major issue in answering the environmental challenges of the 21^{st} century.

Many processes have been envisaged for making possible the extraction of various families of additives from plastics, including in particular PVC plastic. For example and in a non-exhaustive way, Patents EP 1 311 599 and JP2007191586 both propose a first stage of dissolution of the PVC resin and of at least one family of additives among plasticizers of phthalate type, flame retardants or lead-based metal stabilizers by a first organic solvent, followed by one or more stage(s) of liquid-liquid extraction of at least one family of additives from the solution obtained previously via the use of at least one other solvent (organic and/or aqueous) different from the first organic solvent. Patent JP2007092035 discloses another possible implementation example with dissolution of the PVC resin and of at least the additives of phthalate type via the use of a mixture of solvents under supercritical conditions and the recovery of said phthalates from this same mixture of solvents after “rupture” of said supercritical conditions, then a stage of extraction of the lead-based additives from the residual solid phase containing the PVC resin via the use of at least one liquid surfactant.

Despite these advances, to remove all the additives from a PVC plastic, and even more from a mixture of PVC-based plastics resulting from various formulations (for example constituents of post-consumption waste), still today represents a scientific and industrial challenge. The abovementioned dissolution stage is advantageous firstly for removing a part of the additives, which are insoluble in the chosen solvent(s). On the other hand, the additives soluble in the solvent(s) are particularly difficult to separate, in particular as a result of their very varied chemical natures. A first approach can consist in extracting them on the basis of physicochemical properties, such as their polarity, their solubility, their boiling point, their density, and the like, but this can lead to a multiplication of the purification stages, in view of the plurality and diversity of the additives present. Moreover, to obtain a stream of at least one purified PVC polymer is generally not a sufficient condition to ensure the economic viability of a process for the regeneration of PVC-based objects. The main reason frequently advanced is the difficulty in finding an economically viable balance between the resale cost (equivalent to the added value) of the products obtained and the cost of the unit operations carried out in said regeneration process, which is all the truer if there are many separation stages envisaged. To finish, to treat a plastic feedstock from PVC-based plastic waste involves providing a robust and versatile process in order to take into account the variability of the additives present as a function of the origin of the waste under consideration (in terms of targeted use and of production date).

The present invention thus proposes another approach for responding to the problems explained above, based on the exploitation of the difference in size, more precisely in the hydrodynamic volume, between the polymer macromolecules and the molecules of the impurities, such as those of the additives.

The present invention consequently makes it possible, starting from a polymer solution containing at least one PVC polymer dissolved in a dissolution medium and the associated soluble additives, to selectively extract said PVC polymer from the medium, whatever the nature of said additives.

The technique of separation by criterion of size already exists and is commonly used as an analytical method to determine the molecular weight of polymers. This method, called size exclusion chromatography (SEC), consists in implementing a fixed bed operated batchwise and comprising several levels of porosity. Small molecules explore said fixed bed as far as the smallest porosities, the associated elution times then being high, while big molecules, such as polymers, travel only through the biggest pores and exhibit short elution times, thus inducing the desired separation. In so far as the additives commonly used for the formulations of PVC-based plastics exhibit a size of a region much smaller than that of the polymer chains of the PVC resin, the principle of size exclusion chromatography may thus be applied for the purification of PVC-based plastics. However, the industrial implementation of a process using such a principle is problematic, mainly because of the non-continuous aspect of the batch process. Furthermore, such a process in batch mode would require a significant consumption of eluent in order to ensure efficient separation, which directly impacts the profitability, the productivity and the ecological footprint of the process.

Simulated Moving Bed (SMB) technology, a concept invented in 1961, makes possible the continuous functioning of a discontinuous “chromatographic” process, in particular by adsorption, with an increase in the productivity and a limitation on the amount of eluent consumed, while ensuring efficient separation. Many industrial references to this technology exist, in particular for separations by adsorption which are used in particular for the separation of xylenes with the Eluxyl® or Parex® processes (cf. the publication Simulated Moving Bed Technology: Principles, Design and Process Applications, A. E. Rodrigues, Elsevier, 2015). The only large-scale application of a size-exclusion simulated moving bed (or SMB-SEC for Simulated Moving Bed with Size Exclusion Chromatography) concerns the separation of n-paraffins from isoparaffins, the outlines of which are specified in U.S. Pat. No. 2,985,589. Recent publications mention the use of size-exclusion simulated moving bed (SMB-SEC) technology for the fractionation of polyethylene glycols of varied molecular weights (M. T. Liang et al., J. Chromatogr. A, 2012, 1229, 107) or for the separation of proteins (E. J. Freydell et al., Chem. Eng. Sc., 2010, 65, 4701). More particularly, U.S. Pat. No. 6,551,512 proposes a method for the separation of proteins from liquid compositions, such as milk, by size exclusion in a simulated moving bed. Finally, a publication mentions the use of SMB-SEC in a process for the recycling of materials included in the composition of WEEE (waste electrical and electronic equipment). The WEEE is based on polycarbonate and also comprises poly(styrene-co-acetonitrile) (SAN) and additives, such as flame retardants. It is the latter that the Weeden team seeks to separate from a ternary solution containing SAN and two flame-retardant compounds, resorcinol bis(diphenyl phosphate) and bisphenol A bis(diphenyl phosphate), in an acetone-dichloromethane solvent mixture (G. S. Weeden et al., Journal of Chromatography A, 2015, 1422, 99).

The application of SMB-SEC technology as a method for the purification of PVC-based plastic waste, in order to obtain a stream of purified PVC polymer, making possible its reuse as RSM in the manufacture of new plastic objects, has never been proposed.

It is thus an objective of the present invention to overcome the problems of the prior art and to participate in the recycling of plastics, in particular in the recycling of PVC plastics. More particularly, it is targeted at providing an efficient, simple and economically viable process for the treatment of all types of PVC feedstocks in order to obtain a stream of purified PVC polymer, compatible with the regulations in force and reusable in the manufacture of new plastic objects. Specifically, the present invention seeks to efficiently separate the impurities from waste PVC plastics and to recover purified PVC resins, which may be used in the manufacture of new PVC-based objects, by using a process with a number of unit stages which are limited, thus making it possible to limit the costs of the process and to improve its ecological performance qualities.

### SUMMARY OF THE INVENTION

Thus, the present invention proposes, according to a first aspect, a process for the recovery of a stream of at least one purified PVC polymer from a plastic feedstock, comprising:
a) a dissolution stage comprising bringing the plastic feedstock into contact with a dissolution solvent, in order to obtain at least one crude polymer solution;
b′) optionally a stage of separation of the insoluble materials from the crude polymer solution obtained at the end of stage a), in order to obtain at least one clarified polymer solution;
b) a stage of extraction by size exclusion of the crude polymer solution obtained at the end of stage a) or optionally of the clarified polymer solution obtained at the end of stage b′), in order to obtain a purified polymer solution,
   wherein said stage of extraction by size exclusion implements at least one train of n fixed beds of a size exclusion solid, n being an integer greater than or equal to 4, the n fixed beds of the size exclusion solid being in series,
   said train of fixed beds of stage b) being fed with crude or optionally clarified polymer solution at at least one point of injection F of the polymer solution and with an eluent at at least one point of injection S of the eluent,
   wherein said train of fixed beds of stage b) implements at least one withdrawal of an extract at at least one point of withdrawal E of the extract, and at least one withdrawal of a raffinate at at least one point of withdrawal R of the raffinate,
   wherein the points of injection of the polymer solution and of the eluent and the points of withdrawal of the extract and of the raffinate are distinct from one another and distributed so that they determine at least three, preferably four, successive main zones of operation of the n fixed beds:
a zone I of elution of the impurities, located between the point of injection of the eluent and the point of withdrawal of the extract;
a zone II of elution of at least one PVC polymer, located between the point of withdrawal of the extract and the point of injection of the polymer solution;
a zone III of retention of the impurities, located between the point of injection of the polymer solution and the point of withdrawal of the raffinate; and
optionally a zone IV, located between the point of withdrawal of the raffinate and the point of injection of the eluent,
   wherein the points of injection and of withdrawal are shifted over time by one fixed bed of size exclusion solid according to a frequency determined by a predetermined permutation period,
   wherein the raffinate is recovered in order to constitute, at least in part, the purified polymer solution,
c) a solvent-polymer separation stage, for separating the purified polymer solution into a stream of purified PVC polymer and at least one solvent fraction comprising dissolution solvent.

The advantage of the process of the invention is to propose a process for the efficient treatment of a feedstock comprising PVC-based plastics, especially plastic waste in particular resulting from collection and sorting channels, so as to recover the PVC resins which it contains in order to be able to recycle them in all types of applications. This is because the process according to the invention makes it possible to obtain a stream of purified PVC polymer, very advantageously less coloured than the plastic feedstock, indeed even colourless, and preferably deodourized. In particular, the stream of purified PVC polymer obtained at the end of the process according to the invention advantageously comprises a content of impurities, and in particular of additives, and a content of solvent, in particular of dissolution and/or eluent solvent, which are negligible or at least sufficiently low for the stream of purified PVC polymer to meet the regulations in force and to be able to be introduced into any formulation of plastics in place of virgin PVC resins. For example, the stream of purified PVC polymer obtained exhibits (contents expressed as percentages by weight with respect to the total weight of the stream of purified PVC polymer obtained):
a content of less than 0.1% by weight of phthalates subject to authorization by the REACH regulation in Europe (Annex XIV of Regulation (EC) No. 1907/2006 of the European Parliament and of the Council of 18 Dec. 2006),
a content of less than 0.1% by weight of the element lead,
a content of less than 0.1% by weight, preferably of less than or equal to 0.01% by weight, of the element cadmium,
more generally, a content of less than or equal to 10% by weight, preferably of less than or equal to 5% by weight, preferentially of less than or equal to 1.0% by weight and more preferably still of less than or equal to 0.5% by weight, indeed even of less than or equal to 0.1% by weight, of impurities, and
more generally, a content of less than or equal to 10% by weight, preferably of less than or equal to 5% by weight, preferentially of less than or equal to 1.0% by weight and more preferably still of less than or equal to 0.1% by weight of solvent.

The process according to the invention thus proposes a simple scheme corresponding to a minimum sequence of operations, which makes it possible to free the PVC-based plastic waste of at least a part of their impurities, in particular of at least a part of the additives, and to recover at least one purified PVC polymer, so as to be able to upgrade the PVC plastic waste by recycling of said purified PVC polymer.

The invention has the further advantage of participating in the recycling of plastics and in the preservation of fossil resources, by making possible the upgrading of plastic waste, in particular PVC-based plastic waste. This is because it makes possible the purification of PVC plastic waste for the purpose of obtaining streams of purified PVC polymer with a reduced content of impurities, which may be reused to form new objects. The streams of purified PVC polymer obtained may thus be used directly in formulations as a mixture with additives, for example dyes, pigments, other polymers, in place of or as a mixture with virgin PVC resins, for the purpose of obtaining plastic products with use, aesthetic, mechanical or rheological properties facilitating their reuse and their upgrading.

The present invention also relates, according to a second aspect, to a device for extraction by size exclusion of PVC polymer from a polymer solution, said device comprising:
n fixed beds of a size exclusion solid, n being an integer greater than or equal to 4, preferably of between 4 and 30, in a preferred way between 12 and 15, said size exclusion solid having volume-average pore diameter of preferably between 1 and 500 nm, preferably between 2 and 100 nm, preferentially between 2 and 50 nm, preferentially between 3 and 30 nm, and in preferred way being preferably a silica gel, a grafted silica, a carbon molecular sieve or their mixtures,
   the n fixed beds of the size exclusion solid being distributed in one or more column(s), the n beds being connected in series and preferably in a closed loop,
N systems for injection of the polymer solution, N systems for injection of an eluent, N systems for withdrawal of an extract and N systems for withdrawal of a raffinate, N being an integer preferably equal to n, said injection and withdrawal systems being located between two consecutive beds or optionally upstream of the first bed,
   wherein the systems for injection of the polymer solution and of the eluent and/or the systems for withdrawal of the extract and of the raffinate which are located at one and the same position are distinct or identical,
each injection and withdrawal system comprising valves suitable for allowing or not allowing the passage of a stream of polymer solution and/or of eluent and/or of extract and/or of raffinate, preferably a series of on-off valves, controlled by an automatic sequence, or a single rotary valve, so as:
   to define, at an instant t, a point of injection of the polymer solution, a point of injection of the eluent, a point of withdrawal of the extract and a point of withdrawal of the raffinate, said points of injection and of withdrawal being distinct from one another and determining at least three, preferably four, successive main zones of operation of the n fixed beds:
      a zone I of elution of the impurities, comprised between a point of injection of the eluent and a point of withdrawal of the extract;
      a zone II of elution of at least one PVC polymer, comprised between the point of withdrawal of the extract and a point of injection of the polymer solution;
      a zone III of retention of the impurities, comprised between the point of injection of the polymer solution and a point of withdrawal of the raffinate; and
      optionally a zone IV, comprised between the point of withdrawal of the raffinate and the point of injection of the eluent,
      and to make possible, over time, a shifting in the points of injection and of withdrawal, synchronously or non-synchronously, according to a frequency determined by a predetermined permutation period, by one fixed bed of size exclusion solid per permutation period.

The present invention also relates, according to a third aspect, to a device for treatment of a plastic feedstock in order to obtain a stream of purified PVC polymer, comprising:
dissolution means for bringing the plastic feedstock and a dissolution solvent into contact, so as to dissolve at least in part said plastic feedstock in said dissolution solvent and to obtain a crude polymer solution;
optionally solid-liquid separation means suitable for separating insoluble materials in suspension in the crude polymer solution;
at least one device for extraction by size exclusion according to the invention;
means for separation of the dissolution solvent and optionally of the eluent from a stream of purified PVC polymer.

### LIST OF THE FIGURES

FIG. 1 represents a particular embodiment of the stage of extraction by size exclusion of the present invention, at a given instant t of the process, in which said stage of extraction by size exclusion implements 15 fixed beds of size exclusion solid, of silica gel type, distributed in a single column, said beds being connected together in series with respect to one another and in a closed circuit, a pump located between bed No. 15 and bed No. 1 making it possible to connect bed No. 15 and bed No. 1 in series.

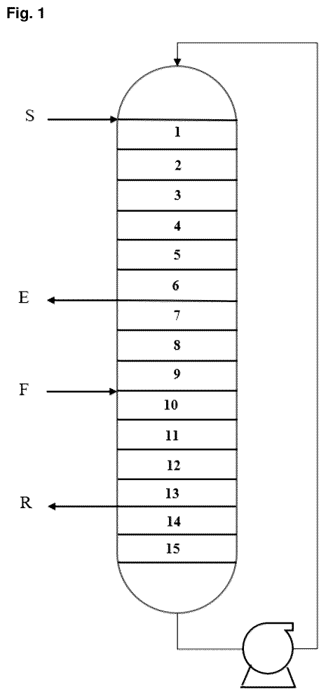

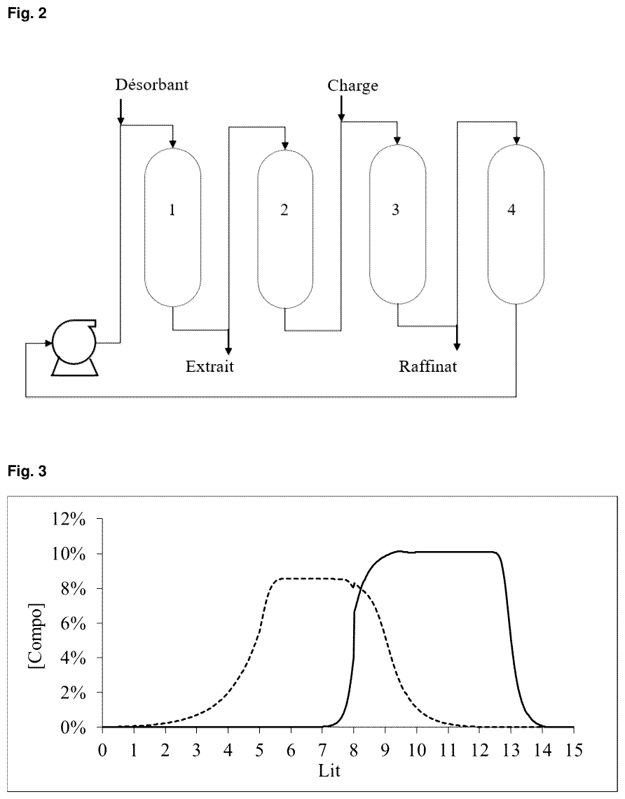

In this particular embodiment and at this instant t:
the crude polymer solution resulting from the dissolution stage a) (not represented in FIG. 1) or optionally the clarified polymer solution resulting from the solid-liquid separation stage b′) optionally incorporated in the process (not represented in FIG. 1) is introduced at the injection point F located between bed No. 9 and bed No. 10, these two beds being consecutive, an eluent is introduced at the injection point S located between bed No. 15 and bed No. 1, these two beds being consecutive,
an extract, comprising at least a part of the impurities present in the polymer solution which feeds the column, is withdrawn at the withdrawal point E located between bed No. 6 and bed No. 7, these two beds being consecutive,
a raffinate, composed, at least in part, of a purified polymer solution comprising at least one PVC resin present in the polymer solution which feeds the column, is withdrawn at the withdrawal point R located between bed No. 13 and bed No. 14, these two beds being consecutive.

The combined injection and withdrawal points thus define 4 operating zones:
a zone I of elution of the impurities, located between the injection of the eluent and the withdrawal of the extract, comprising 6 beds,
a zone II of elution of at least one PVC polymer, located between the withdrawal of the extract and the injection of the polymer solution, comprising 3 beds,
a zone III of retention of the impurities, located between the injection of the polymer solution and the withdrawal of the raffinate, comprising 4 beds, and
a zone IV, located between the withdrawal of the raffinate and the injection of the eluent, comprising 2 beds.

FIG. 2 represents another particular embodiment of the stage of extraction by size exclusion of the present invention, at a given instant t of the process, in which said stage of extraction by size exclusion comprises 4 fixed beds of size exclusion solid, of silica gel type, each distributed in a column (i.e. one bed per column), said columns being connected together in series with respect to one another and in a closed circuit, a pump located between column No. 4 and column No. 1 making it possible to connect column No. 4 and column No. 1 in series.

In this particular embodiment and at the instant t:
the polymer solution which feeds the stage of extraction by size exclusion is introduced at the injection point F located between the column 2 and the column 3,
an eluent is introduced at the injection point S located between the column 4 and the column 1,
an extract, comprising at least a part of the impurities present in the polymer solution which feeds the stage of extraction by size exclusion, is withdrawn at the withdrawal point E located between the column 1 and the column 2,
a raffinate, composed, at least in part, of a purified polymer solution comprising at least one PVC resin present in the polymer solution which feeds the stage of extraction by size exclusion, is withdrawn at the withdrawal point R located between the column 3 and the column 4.

FIG. 3 represents the concentration profile obtained in the context of Example 1, for a PVC resin and the additive didecyl phthalate (DiDP), by simulation along the entire length of the simulated moving bed which comprises 15 fixed beds of silica gel according to a 6/3/4/2 configuration. By convention, the injection of the eluent is located upstream of the bed 1 (and downstream of the bed 15). The concentration profile of the PVC resin as a function of the beds is represented by a solid black line and the concentration profile of the additive didecyl phthalate (DiDP) as a function of the beds is represented by the dotted line.

### DESCRIPTION OF THE EMBODIMENTS

### Terminology

Certain definitions and/or details are given below, although more details on the objects defined below may be given later in the description.

The term “PVC-based object” is understood to mean an object, generally a consumer object, which comprises, and preferably consists of, at least one PVC plastic.

The term “polyvinyl chloride plastic”, also known as “PVC plastic”, is understood to mean the combination of a PVC polymer, also known as PVC resin, with various additives chosen as a function of the functionalities required for the PVC plastic, themselves chosen as a function of the intended applications.

The PVC polymer conventionally results from the radical polymerization of vinyl chloride (VCM), a monomer itself obtained from chlorine and ethylene. The present invention makes possible the treatment of any type of PVC plastic feedstock and the recycling of any grade of PVC polymer.

Said additives participating in the composition of a PVC plastic may be organic molecules or macromolecules or else inorganic (nano)particles and are used as a function of the properties which they confer on the PVC resin. Generally and non-exhaustively, the formulation of a PVC plastic involves at least one family of additives which is described below:
stabilizers for limiting the degradation of the polymer chains by dehydrochlorination and/or oxidation under the effect of heat, light, oxygen and/or mechanical stress. The nature of these stabilizers (metal (Pb, Sn, Ca, Zn, Cd) compounds or organic compounds) is a function of the properties required and thus of the targeted applications. Mention is made here of some examples of stabilizers frequently used in the past or at present: lead stearate, dibasic lead stearate, dibasic lead phthalate, zinc stearate, calcium stearate, and the like, taken alone or as a mixture. Costabilizers may also be considered, for example epoxidized oils,
plasticizers in order to induce flexible behaviour, better impact strength and better cold resistance of the PVC plastic, the most widely used forming part of the family of the phthalates. The latter are obtained by reaction between a phthalic anhydride and alcohols having more or less lengthy carbon chains and are composed of a benzene nucleus and of two carboxylic ester groups placed in the ortho position of the benzene nucleus. Dioctyl phthalate or diethylhexyl phthalate (DOP or DEHP), diisononyl phthalate (DINP) and diisodecyl phthalate (DIDP) constitute examples of phthalates very widely used in the past or at present. Other non-phthalic plasticizers are currently used, such as bis(2-ethylhexyl) adipate (DEHA) or cyclohexane-1,2-dicarboxylic acid diisononyl ester (DINCH),
lubricants for controlling intermolecular frictional forces actually within the polymer itself (internal lubricants, such as stearic acid, and the like) or between the polymer and the metal walls of processing tools (external lubricants, such as paraffins, polyethylene waxes, and the like),
inert fillers, most of the time inorganic (CaCO₃, carbon black, kaolin, and the like), which act as diluents or to improve certain mechanical, electrical, thermal, and the like, properties,
dyes and/or pigments (TiO₂, carbon black), the latter being insoluble in the polymer and thus present in the form of particles dispersed in the PVC plastic,
impact modifiers, generally polymers (such as polyacrylates) and copolymers (such as MBS, for methacrylate-butadiene-styrene), the role of which is to reduce the brittleness of the PVC, particularly at low temperature,
other adjuvants: antioxidants, UV-inhibitors, biocides, antistatic agents, flame retardants, reinforcers, and the like.

The term “impurities” is understood to mean all the elements other than the PVC resins constituting a plastic feedstock, in particular resulting from PVC-based plastic waste, which the process according to the invention proposes to treat. Said impurities correspond at least in part to the additives mentioned and described above. Other types of impurities may be usual impurities resulting from the life cycle of PVC-based objects and/or resulting from the collection and sorting circuit, indeed even from pre-treatment operations on PVC-based plastic waste. These usual impurities may be of metallic, organic or inorganic type. They may be residues of constituent materials (excluding PVC plastics) of PVC-based objects or of other objects which have been in contact with the PVC-based objects, stains (food, biomass, soil/rubble, adhesive, and the like), and the like. These usual impurities may thus and non-exhaustively comprise glass, wood, cardboard, paper, metal, rubber, silicones, plastics other than PVC (for example PET, and the like), inorganic elements, and the like. Possible degradation products of the additives formed over time during the lifetime of the PVC-based product are also considered as impurities.

In the present description, the expression “stream of purified PVC polymer” represents the main and upgradable product obtained after treatment of a plastic feedstock, in particular resulting from PVC-based plastic waste, by the process according to the invention. It comprises at least one PVC resin of a given grade, preferably a mixture of PVC resins of the same chemical nature but of variable grades. The term “purified” means in particular that the stream of PVC polymer obtained at the end of the process according to the invention comprises negligible or at least very low, in all cases in accordance with the regulations in force, contents of impurities (including additives) as described above and of at least one solvent as used according to the process of the invention. Thus, more particularly, the stream of at least one purified PVC polymer exhibits a content (contents expressed as percentages by weight with respect to the total weight of the final product, that is to say of the stream of purified PVC polymer obtained):
a content of less than 0.1% by weight of phthalates subject to authorization by the REACH regulation in Europe (Annex XIV of Regulation (EC) No. 1907/2006 of the European Parliament and of the Council of 18 Dec. 2006), in particular of less than 0.1% by weight of phthalates chosen from the list consisting of the following phthalates: dibutyl phthalate (DBP), dioctyl phthalate or diethylhexyl phthalate (DOP or DEHP), benzyl butyl phthalate (BBP), dibutyl phthalate (DBP), diisobutyl phthalate (DIBP), dipentyl phthalate (DPP), diisopentyl phthalate, isopentyl n-pentyl phthalate, dihexyl phthalate, bis(2-methoxyethyl) phthalate, alone or as a mixture,
a content of less than 0.1% by weight of the element lead, in particular of said lead contained in additives of the metal stabilizers type evaluated in the context of the REACH regulation and subject to restrictions (Annex XV) described in detail and adopted between December 2017 and March 2018 by the Risk Assessment Committee (RAC) and the Socio-Economic Analysis Committee (SEAC) of the ECHA,
a content of less than 0.1% by weight, and preferably of less than 0.01% by weight, of the element cadmium, in particular of said cadmium contained in additives of the metal stabilizers type prohibited by the REACH regulation according to the amendment of Annex XVII (Regulation 494/2011 of 20 May 2011),
more generally, a content of less than or equal to 10% by weight, preferably of less than or equal to 5% by weight, preferentially less than 1.0% by weight, more preferably still of less than or equal to 0.5% by weight, indeed even of less than or equal to 0.1% by weight, of impurities, and
more generally, a content of less than or equal to 10% by weight, preferably of less than or equal to 5% by weight, preferentially of less than or equal to 1.0% by weight and more preferably still of less than or equal to 0.1% by weight of at least one solvent used in the process according to the invention.

In the present description, the expression “polymer solution” refers to a liquid medium comprising a dissolution solvent and at least one PVC polymer dissolved, that is to say solvated and dispersed, in said dissolution solvent, the dissolved PVC polymer being initially present in the plastic feedstock treated by the process according to the invention. The polymer solution may additionally comprise soluble impurities (which are dissolved in the dissolution solvent) and/or insoluble impurities (which are in suspension in the polymer solution). Depending on the stages of the process according to the invention which are carried out, said polymer solution may thus comprise impurities in the form of insoluble particles which are advantageously in suspension in said polymer solution (in the case of insoluble impurities of nanometric size, colloidal solutions will then be referred to), soluble impurities dissolved in the dissolution solvent and/or optionally another liquid phase immiscible with said polymer solution.

In the present description, the expression “greater than . . . ” is understood as strictly greater, and symbolized by the sign “>”, and the expression “less than” as strictly less, and symbolized by the sign “<”. When the limit is included, this information will be provided by the respective expressions “greater than or equal to . . . ” (and corresponding to the sign “≥”) and “less than or equal to” (corresponding to the sign “≤”).

In the present description, the term “room temperature” (r.t.) is understood to mean a temperature typically of 20 °C±5 °C and the term “atmospheric pressure” is understood to mean a pressure of 0.101325 MPa.

In the present description, the term “to comprise” is synonymous with (means the same as) “to include” and “to contain”, and is inclusive or open-ended and does not exclude other elements which are not mentioned. It is understood that the term “to comprise” includes the exclusive and closed term “to consist”.

In the present description, the expression “of between . . . and . . . ” means that the limiting values of the interval are included in the described range of values, unless otherwise specified.

In the present description, the various ranges of parameters for a given stage, such as the pressure ranges and the temperature ranges, may be used alone or in combination. For example, in the present description, a range of preferred pressure values may be combined with a range of more preferred temperature values.

Subsequently, particular embodiments of the invention are described. They may be carried out separately or combined together, without limitation of combinations when this is technically achievable.

Subsequently, the term “stage” is used to denote an operation or a group of similar operations carried out on a given stream at a certain point of the process. The process is described in its various stages taken in the order of flow of the streams or products.

To finish, the terms “upstream” and “downstream” are to be understood as a function of the general flow of the fluid(s) or stream(s) in question in the process. More particularly, the terms “upstream” and “downstream” are defined as a function of the flow of the stream which comprises the PVC resins. For example, the terms “upstream” and “downstream” are defined in the size exclusion stage with respect to the stream of polymer solution, that is to say either to the feeding of said stage b) with crude (or clarified) polymer solution or to the point of exit of the polymer solution extracted during this stage b) (i.e. point of withdrawal of the raffinate).

The description of the process according to the invention below refers to the diagrams of FIGS. 1 and 2, illustrating different implementations of the process according to the invention. In accordance with the invention, the process for the recovery of a stream of at least one reusable purified PVC polymer from a plastic feedstock advantageously resulting from PVC-based plastic waste comprises, and may consist of, the following stages:
a) a dissolution stage comprising bringing the plastic feedstock into contact with at least one dissolution solvent, in order to obtain at least one crude polymer solution; then
b′) an optional stage of separation of the insoluble materials from the crude polymer solution, making it possible to advantageously obtain a clarified polymer solution and preferably an insoluble fraction; then
(b) a stage of extraction by size exclusion of the crude polymer solution obtained at the end of stage a) or optionally of the clarified polymer solution obtained at the end of the optional stage b′), making it possible to obtain a purified polymer solution,
   wherein said stage of extraction by size exclusion implements at least one train of n fixed beds of a size exclusion solid, n being an integer greater than or equal to 4, preferably of between 4 and 30, preferentially between 8 and 24, very preferentially between 8 and 21 and in a preferred way between 12 and 15,
   advantageously the n fixed beds of the size exclusion solid being distributed in one or more column(s), preferably in M column(s), M being an integer of between 1 and the total number n of fixed beds of the exclusion solid, the n beds being in series with respect to one another and preferably in a closed loop,
   said at least one train of fixed beds of stage b) being fed with crude or clarified polymer solution at at least one point of injection F of the polymer solution and with an eluent at at least one point of injection S of the eluent,
   wherein said at least one train of fixed beds of stage b) implements at least one withdrawal of an extract at at least one point of withdrawal E of the extract, and at least one withdrawal of a raffinate at at least one point of withdrawal R of the raffinate,
   wherein the points of injection of the polymer solution and of the eluent and the points of withdrawal of the extract and of the raffinate are distinct from one another, advantageously located between two consecutive beds or optionally upstream of the first bed, and distributed so that they determine at least three, preferably four, successive main zones of operation of the n fixed beds:
a zone I of elution of the impurities, located between a point of injection of the eluent and a point of withdrawal of the extract;
a zone II of elution of at least one PVC polymer, located between the point of withdrawal of the extract and a point of injection of the polymer solution;
a zone III of retention of the impurities, located between the point of injection of the polymer solution and a point of withdrawal of the raffinate; and
optionally, and preferably, a zone IV, located between the point of withdrawal of the raffinate and the point of injection of the eluent,
   wherein the points of injection and of withdrawal are shifted over time by one fixed bed of size exclusion solid according to a frequency determined by a predetermined permutation period,
   wherein the raffinate is recovered in order to constitute at least a part, preferably all, of the purified polymer solution; then
(c) a stage of polymer-solvent separation of the purified polymer solution in order to obtain at least one fraction of at least one solvent, comprising in particular dissolution solvent and optionally eluent, and a stream of at least one purified PVC polymer.

### Feedstock

The process according to the invention is fed by a plastic feedstock, in particular based on PVC, and more particularly resulting from PVC-based plastic waste. It may also be referred to as “PVC feedstock” and comprises at least one PVC plastic.

Said plastic feedstock is advantageously a feedstock of PVC to be recycled of “production scraps” type, i.e. waste resulting from the processes for the production of the PVC polymer during its polymerization or of the PVC plastic during its formulation/forming or of the PVC-based object during its production, or of “post-consumption waste” type, i.e. waste generated after consumption by the user of said PVC-based object. In particular, the plastic feedstock to be recycled may result from any existing networks or collection and sorting channels for production scraps and/or post-consumption waste making it possible to isolate a stream based on at least one PVC plastic, in particular the networks or collection and sorting channels specific to plastic waste.

Thus, the plastic feedstock, which is typically of “production scraps” type and/or of “post-consumption waste” type, generally comes from the main fields of application which use PVC plastic, such as, and non-exhaustively, the following fields: building and construction, packaging, motor vehicles, electrical and electronic equipment, sports, medical equipment, and the like. Preferably, the PVC feedstock comes from the building and construction field. More precisely, PVC-based objects are generally used in these fields as profiles (windows, doors, blinds, cases for roller shutters), pipes and fittings, various rigid and bottles, rigid plates and films, flexible films and sheets, flexible tubes and profiles, cables, floor coverings, coated fabrics, and the like.

Advantageously, the plastic feedstock comprises at least 50% by weight, preferably at least 70% by weight, in a preferred way at least 90% by weight and more preferably still at least 95% by weight of PVC plastic.

The plastic feedstock treated in the process for the recovery of a stream of reusable purified PVC polymer according to the invention is in the form of particles. Thus, if the PVC feedstock is in an initial form which is that specific to production scraps or to post-consumption waste, in particular in the latter case in the initial form of PVC-based objects, it may undergo, beforehand, a conditioning stage (as described below) comprising at least a grinding or a shredding to form a PVC feedstock in the form of particles. Depending on the channels and/or networks from which these production scraps and/or PVC-based objects at the end of life result, the PVC waste may be ground and/or washed and/or subjected to any other conditioning stage as described below, in order to form the PVC feedstock in the form of particles which are suitable for the process according to the invention. For example, the PVC feedstock may advantageously be in the form of ground and optionally washed materials, the greatest dimension of which is less than or equal to 20 cm, preferably less than or equal to 10 cm, in a preferred way less than or equal to 1 cm and more preferably still less than or equal to 5 mm. The PVC feedstock may also advantageously be in micronized solid form, that is to say in the form of particles preferably having a mean size of less than 1 mm, for example of between 10 micrometres (μm) and 800 micrometres (μm). The mean size advantageously corresponds to the mean diameter of the spheres in which said particles are circumscribed.

Thus, the plastic feedstock which feeds the process according to the invention is advantageously in the form of particles, typically having a mean size of between 10 μm and 20 cm, for example particles of ground materials type having a mean size of between 1 mm and 20 cm, preferably of between 1 mm and 10 cm, more preferentially of between 1 mm and 1 cm, more preferentially still of between 1 mm and 5 mm, or particles resulting from a micronization (very fine grinding to produce a powder) with a mean size of less than 1 mm, preferably of between 10 μm and 800 μm.

As already mentioned, the PVC feedstock may also comprise usual impurities, often “macroscopic” impurities, such as glass, wood, cardboard, paper, metal, rubber, silicones, plastics other than PVC (for example PET, and the like), inorganic elements, and the like. Advantageously, the PVC feedstock comprises at most 50% by weight, preferably at most 30% by weight, in a preferred way at most 10% by weight and more preferably still at most 5% by weight of “macroscopic” impurities. An optional preconditioning stage can make it possible, besides putting the abovementioned feedstock in the form of particles, to remove all or some of said usual impurities.

The various stages of the process according to the invention leading to the stream of at least one reusable purified PVC polymer are described in detail in the sections which follow.

### Optional Stage of Preconditioning of the PVC Feedstock

According to the invention, the process may comprise a stage of preconditioning of the PVC feedstock (not represented in FIGS. 1 and 2) comprising at least one stage of grinding or shredding or micronizing the PVC feedstock to form a PVC feedstock in the form of solid particles as is defined above, capable of being sent to the dissolution stage a). This preconditioning stage may additionally comprise one or more stages mentioned in the following non-exhaustive list: grinding by micronization, sorting, oversorting, washing, drying, and the like. Depending on the nature of the PVC feedstock treated, the stage or stages, and their possible frequencies and sequences, which are involved in the preconditioning stage, are in particular chosen by a person skilled in the art so as to limit the amount of usual impurities and to reduce the size of the solid elements of which the PVC feedstock is initially composed.

For example, the preconditioning stage makes it possible to provide a PVC feedstock in the form of particles, for example of ground materials, which are washed, with a mean size of less than or equal to 5 mm, preferably of between 1 mm and 5 mm, the content of usual impurities of which is preferably at most 10% by weight and more preferably at most 5% by weight. Said preconditioned PVC feedstock may also be in the form of micronized solid particles, that is to say in the form of particles having a mean size of less than 1 mm, for example of between 10 μm and 800 μm.

The stage of preconditioning of the PVC feedstock may comprise a stage of drying of the PVC feedstock.

### Dissolution Stage a)

The process according to the invention comprises a dissolution stage a) in which the PVC feedstock (or plastic feedstock), advantageously in the form of particles, is brought into contact with a dissolution solvent in order to obtain at least one, preferably just one, crude polymer solution. This stage advantageously makes possible the dissolution of at least a part, preferably of all, of the PVC resins contained in the plastic feedstock.

The term “dissolution” should be understood as meaning any phenomenon resulting in there being obtained at least one polymer solution, that is to say a liquid comprising at least the PVC resins dissolved in a solvent, more particularly in the dissolution solvent. A person skilled in the art is fully aware of the phenomenon/phenomena involved in the dissolution of polymers, the phenomenon/phenomena comprising at least a mixing, a homogenization, a solvating, a disentangling and a dispersion of the polymer chains and more particularly in this instance of the PVC polymer chains.

The dissolution solvent is chosen, as a result of its physicochemical properties, for its ability to solvate, disentangle and disperse the PVC polymer chains. In this, a person skilled in the art may rely on the knowledge of the Hildebrand and/or Hansen solubility parameters of the solvents to define, with respect to these same parameters specific to PVC resins, the solvent or mixture of solvents best suited to carrying out the dissolution stage a) of the process according to the invention. More particularly, the dissolution solvent is a solvent or a mixture of solvents, in particular organic solvent(s), preferably chosen so that its Hansen parameters are within the Hansen sphere of the targeted PVC polymer. The Hansen theory makes it possible to predict the solubility of a polymer, in particular of a thermoplastic, such as PVC, in a solvent, by virtue of the determination of the Hansen solubility parameters and sphere respectively for the solvent and the polymer, as a function of several parameters, in particular of their polar, hydrogen bonding and dispersion parameters. If a solvent or mixture of solvents exhibits Hansen parameters in the Hansen sphere of the PVC polymer, said PVC polymer should be at least partially, preferably entirely, soluble in said solvent. Thus, the dissolution solvent is advantageously an organic solvent or a mixture of organic solvents, preferably chosen from: ketones (acetone; methyl ethyl ketone or MEK; diethyl ketone or DEK; methyl propyl ketone; 4-heptanone; 2,4-dimethyl-3-pentanone; methyl isobutyl ketone or MIBK; diisobutyl ketone; methyl isoamyl ketone; 4-hydroxy-4-methylpentan-2-one; and the like), cyclic ketones (cyclopentanone; cyclohexanone; isophorone; and the like), amides (N,N-diethylformamide; N,N-dimethylacetamide; N,N-dimethylformamide or DMF; and the like.), cyclic amides (2-pyrrolidone; N-methyl-2-pyrrolidone or NMP; and the like), esters (methyl acetate; ethyl acetate; propyl acetate; butyl acetate; amyl acetate; 2-butoxyethyl acetate; n-butyl propionate; propyl propionate; methyl propionate; allyl acetate; 2-(2-butoxyethoxy)ethyl acetate; propylene glycol methyl ether acetate; propylene glycol ethyl ether acetate; butyl benzoate; benzyl benzoate; ethyl lactate; and the like), cyclic esters (γ-butyrolactone or GBL; γ-valerolactone or GVL; caprolactone; and the like), ethers (methoxycyclopentane or CPME; propylene glycol phenyl ether; diethylene glycol butyl ether; dipropylene glycol butyl ether; propylene glycol methyl ether; propylene glycol butyl ether; dipropylene glycol methyl ether; ethylene glycol butyl ether; and the like), cyclic ethers (tetrahydrofuran or THF; 1,3-dioxolane; 2-hydroxymethyloxolane; and the like), chlorinated solvents (dichloromethane; trichloromethane or chloroform; tetrachloromethane; trichloroethylene; and the like), hydrocarbons (xylene; toluene; limonene; isohexane; cyclohexane; and the like), sulfur-based solvents (dimethyl sulfoxide or DMSO; sulfolane; and the like), nitrogenous solvents (1-nitropropane; and the like), dihydrolevoglucosenone or cyrene, and the like. Preferably, the dissolution solvent is chosen from ketones, cyclic ketones and cyclic esters, such as MEK, DEK, 4-heptanone, 2,4-dimethyl-3-pentanone, MIBK, cyclopentanone, GBL, GVL, taken alone or as a mixture. More preferably still, the dissolution solvent is chosen from DEK, 4-heptanone, 2,4-dimethyl-3-pentanone, GBL and GVL, taken alone or as a mixture.

Stage a) of dissolution of the PVC feedstock is preferably carried out at a dissolution temperature of between room temperature and 200 °C, preferably between 20 °C and 200 °C, preferably of between 40 °C and 180 °C, more preferably of between 60 °C and 150 °C, and advantageously at a dissolution pressure of between atmospheric pressure and 11.0 MPa absolute, preferably between 0.1 and 11.0 MPa absolute, preferably between 0.1 and 5.0 MPa absolute, more preferably between 0.1 and 2.0 MPa absolute. The pressure and temperature operating conditions are thus chosen so as to keep the dissolution solvent, at least in part and preferably completely, in the liquid state, while the soluble fraction of the PVC feedstock, in particular the PVC resins and at least a part of the impurities, is advantageously dissolved, at least in part and preferably completely. Very advantageously, the temperature and pressure conditions of the dissolution stage a) are adjusted so that the dissolution solvent+PVC resin(s) mixture is a single-phase mixture, it being possible for insoluble impurities optionally to be in suspension in said mixture.

Very advantageously, the dissolution stage a) is carried out with a residence time of between minute (min) and 10 hours (h), preferably between 10 min and 4 h, more preferably between 10 min and 2 h. The residence time is understood as the residence time at the dissolution temperature and at the dissolution pressure, that is to say the time of processing of the plastic feedstock with the dissolution solvent at the dissolution temperature and at the dissolution pressure, in stage a).

Preferably, stage a) is fed with said plastic feedstock and with said dissolution solvent, so that the amount by weight of PVC resin(s) present in the plastic feedstock, with respect to the weight of the dissolution solvent, is of between 2% and 30% by weight, preferably of between 5% and 20% by weight and more preferably still between 10% and 15% by weight.

So as to make it possible for the dissolution solvent and the plastic feedstock to be brought into contact and to make possible the dissolution in the dissolution solvent of at least a part, preferably of all, of the PVC resins contained in the plastic feedstock, the dissolution stage a) may implement different equipment. Thus, stage a) may advantageously implement at least one dissolution equipment, one mixing equipment and/or one transportation equipment. These equipment (or devices) can, for example, be a static mixer, an extruder, a pump, a reactor, a co-or countercurrent column. The transportation equipment, in particular for the transportation of fluids, such as liquids or solids, are well known to a person skilled in the art. In a non-limiting way, the transportation equipment may comprise a compressor, a pump, an extruder, a vibrating tube, an endless screw or a valve. The equipment may also comprise or be combined with heating systems (for example, oven, exchanger, heating cable, and the like) in order to achieve the conditions necessary for the dissolution. Very particularly, the dissolution stage a) may implement a reactor stirred by a mechanical stirring system and/or by a recirculation loop and/or by fluidization, for example a perfectly stirred reactor of batch or continuous type, or a reactor of rotating drum type.

The dissolution stage a) is at least fed by the plastic feedstock (or PVC feedstock) and by the dissolution solvent, in particular in the form of one or more streams of dissolution solvent, advantageously by means of one or more transportation device(s). The PVC feedstock may be introduced in the form of a stream of solid particles distinct from the stream(s) of dissolution solvent. A part or all of the PVC feedstock may also feed stage a) as a mixture with a part or all of the dissolution solvent, in particular in the form of a suspension of solid particles in the liquid solvent, it being possible for the remainder of the solvent and/or of the feedstock, if appropriate, to feed stage (a) separately.

Stage a) may be fed continuously or batchwise with said plastic feedstock and/or with said dissolution solvent, as a mixture or separately.

Preferably, the dissolution stage a) may be carried out in a reactor of the type stirred by a mechanical stirring system and/or by a recirculation loop and/or by fluidization and/or by ultrasound, for example a perfectly stirred reactor of batch or continuous type, or a reactor of rotating drum type. Moreover, the introduction of the PVC feedstock in the form of a stream of solid particles, independent of the stream(s) of dissolution solvent, is preferred.

Advantageously, the dissolution solvent used in stage a) comprises, preferably consists of, fresh solvent (or a contribution of fresh solvent) and/or a stream of recycled solvent resulting from a subsequent stage of the process, in particular resulting at least in part from the recovery stage c).

In accordance with the invention, said dissolution stage a) makes it possible to obtain at least one, preferably just one, polymer solution, referred to here as crude polymer solution, comprising at least the dissolution solvent and at least the PVC resin(s) dissolved in said dissolution solvent. In general, the crude polymer solution also comprises soluble impurities which are also dissolved in the dissolution solvent and optionally insoluble impurities in suspension.

### Optional Stage B′) of Separation of the Insoluble Materials

The process according to the invention may optionally comprise a stage b′) of separation of the insoluble materials from the crude polymer solution, in particular by solid-liquid separation, which is advantageously located upstream of stage b) of extraction by size exclusion. Stage b′) of separation of the insoluble materials thus makes it possible, when it is incorporated in the process according to the invention, to obtain a clarified polymer solution, which is a polymer solution, at least a part, preferably all, of the insoluble impurities of which have been removed. Said stage b′) of separation of the insoluble materials also makes it possible advantageously, when it is incorporated in the process according to the invention, to separate an insoluble fraction, which comprises a part, and preferably all, of the insoluble impurities in particular in suspension in the crude polymer solution resulting from stage a). The insoluble impurities removed during stage b′) of separation of the insoluble materials are, for example, additives initially present in PVC plastics (pigments, fillers, other polymers, and the like), usual impurities (inorganic compounds, glass, wood, paper, metal, other polymers) and/or degradation products, as described above in this description. Preferably, stage b′) also makes it possible to obtain a clarified polymer solution and an insoluble fraction.

When it is carried out, this separation stage b′) advantageously makes it possible, besides the removal of at least a part of the insoluble impurities, to limit operating problems, in particular of clogging and/or erosion type, in the stages of the process located downstream, while contributing to the purification of the PVC feedstock. Preferably, the process according to the invention comprises a stage b′) of separation of the insoluble materials.

Advantageously, the stage of separation of the insoluble materials, when it is carried out, is located upstream of stage b) of extraction by size exclusion and typically downstream of the dissolution stage a).

Stage b′) of separation of the insoluble materials is advantageously carried out under temperature and pressure conditions close to those of stage a). Very advantageously, stage b′) of separation of the insoluble materials is carried out at the temperature and pressure conditions of the dissolution stage a), as are defined above. Thus, very advantageously, stage b′) is carried out at a temperature of between room temperature and 200 °C, preferably between 20 °C and 200 °C, preferably of between 40 °C and 180 °C, more preferably of between 60 °C and 150 °C, and advantageously at a pressure of between atmospheric pressure and 11.0 MPa absolute, preferably between 0.1 and 11.0 MPa absolute, preferably between 0.1 and 5.0 MPa absolute, more preferably between 0.1 and 2.0 MPa absolute.

When it is incorporated in the process, stage b′) of separation of the insoluble materials is preferably fed by the crude polymer solution resulting from stage a).

Advantageously, the optional stage b′) may implement a section comprising at least one solid-liquid separation equipment, for example a knockout drum, a decanter, a centrifugal decanter, a centrifuge, a filter, a sand filter, a tangential filter implementing in particular a membrane and/or a depth filter, optionally in the presence of filtration adjuvants (for example diatomaceous earths or sand), an eddy current separator, an electrostatic separator, a triboelectric separator, preferably a decanter, a filter, a sand filter and/or an electrostatic separator. Advantageously, a self-cleaning filter may be used, the cleaning or declogging for removing the insoluble materials being carried out in particular using a solvent stream.

The removal of the insoluble fraction may require the use of equipment making possible the transportation and optionally making possible the removal of solvent which may be impregnated into the insoluble fraction separated. For example, stage b′) may implement a conveyor, a vibrating tube, an endless screw, an extruder or a stripper. Stage b′) may thus implement transportation equipment in order to discharge the insoluble fraction and/or to remove solvent possibly entrained with the insoluble fraction separated. Advantageously, at least a part of the solvent possibly entrained with the insoluble fraction separated is recovered and recycled in the process.

According to a particular embodiment, stage b′) of separation of the insoluble materials implements at least two, and generally less than five, solid-liquid separation equipment in series and/or in parallel. The presence of at least two solid-liquid separation equipment in series makes it possible to improve the removal of the insoluble materials, while the presence of equipment in parallel makes it possible to manage the maintenance of said equipment and/or declogging operations.

Certain insoluble impurities, in particular certain pigments and inorganic fillers, conventionally added during the formulation of polymers, may be introduced in the form of particles less than 1 μm in size. This is, for example, the case of titanium dioxide, calcium carbonate and carbon black. According to one embodiment, said stage b′) of separation of the insoluble materials advantageously implements an electrostatic separator, which makes it possible to efficiently remove, at least in part, the insoluble particles less than 1 μm in size. According to another embodiment, stage b′) of separation of the insoluble materials implements a sand filter, in order to remove the particles of different sizes and in particular particles less than 1 μm in size. According to yet another embodiment, stage b′) of separation of the insoluble materials implements a tangential filter implementing in particular a membrane and/or a depth filter, optionally in the presence of filtration adjuvants, such as diatomaceous earths.

In accordance with the invention, said optional stage b′) of separation of the insoluble materials makes it possible, when it is incorporated in the process, to obtain at least one clarified polymer solution comprising at least the dissolution solvent and at least the PVC resin(s) dissolved in said solvent. Thus, at least a part, and preferably all, of the insoluble impurities potentially present in suspension in the crude polymer solution obtained at the end of stage a) of the process according to the invention is removed from the polymer solution in stage b′).

### Stage (b) of Extraction by Size Exclusion

The process according to the invention comprises a stage b) of extraction by size exclusion, which in particular is fed by an eluent and the crude polymer solution resulting from stage a) or optionally by the clarified polymer solution resulting from stage b′) of separation of the insoluble materials. Advantageously, stage b) of extraction by size exclusion makes it possible to obtain at least one purified polymer solution and preferably a waste solvent, in particular laden with impurities.

The polymer solution which feeds stage b) of extraction by size exclusion, in particular the crude polymer solution resulting from stage a) or optionally the clarified polymer solution resulting from stage b′) of separation of the insoluble materials, generally comprises dissolved impurities, which are advantageously removed, at least in part and preferably completely, during stage b), in particular by bringing the crude or optionally clarified polymer solution into contact with a size exclusion solid in the presence of an eluent. This is because stage b) of extraction by size exclusion makes possible separation of the compounds present in the crude or optionally clarified polymer solution, in particular the separation of the dissolved PVC resin(s) and of the solubilized impurities, according to their size, in particular at the molecular scale (or rather their hydrodynamic volume), by simulated counter-current chromatography or simulated moving bed chromatography, denoted below by the process term SMB. Very advantageously, this extraction stage of the process according to the invention makes possible the selective separation of the PVC resin(s), dissolved in the dissolution solvent, from the solubilized impurities present in the polymer solution which feeds said stage b) (i.e. the crude or optionally clarified polymer solution). Stage b) thus makes it possible to produce a purified polymer solution, said purified polymer solution being a polymer solution freed of at least a part, preferably all, of the soluble impurities present in the polymer solution which feeds said stage b), that is to say present in the crude or optionally clarified polymer solution.

Preferably, the eluent which feeds the extraction stage b) is a solvent, in particular an organic solvent or a mixture of organic solvents, preferably chosen so that its Hansen parameters are within the Hansen sphere of the targeted PVC polymer. Preferably, the eluent which feeds the extraction stage b) is a solvent, in particular an organic solvent or a mixture of organic solvents chosen from: ketones (acetone; methyl ethyl ketone or MEK; diethyl ketone or DEK; methyl propyl ketone; 4-heptanone; 2,4-dimethyl-3-pentanone; methyl isobutyl ketone or MIBK; diisobutyl ketone; methyl isoamyl ketone; 4-hydroxy-4-methylpentan-2-one; and the like), cyclic ketones (cyclopentanone; cyclohexanone; isophorone; and the like), amides (N,N-diethylformamide; N,N-dimethylacetamide; N,N-dimethylformamide or DMF; and the like.), cyclic amides (2-pyrrolidone; N-methyl-2-pyrrolidone or NMP; and the like), esters (methyl acetate; ethyl acetate; propyl acetate; butyl acetate; amyl acetate; 2-butoxyethyl acetate; n-butyl propionate; propyl propionate; methyl propionate; allyl acetate; 2-(2-butoxyethoxy)ethyl acetate; propylene glycol methyl ether acetate; propylene glycol ethyl ether acetate; butyl benzoate; benzyl benzoate; ethyl lactate; and the like), cyclic esters (γ-butyrolactone or GBL; γ-valerolactone or GVL; caprolactone; and the like), ethers (methoxycyclopentane or CPME; propylene glycol phenyl ether; diethylene glycol butyl ether; dipropylene glycol butyl ether; propylene glycol methyl ether; propylene glycol butyl ether; dipropylene glycol methyl ether; ethylene glycol butyl ether; and the like), cyclic ethers (tetrahydrofuran or THF; 1,3-dioxolane; 2-hydroxymethyloxolane; and the like), chlorinated solvents (dichloromethane; trichloromethane or chloroform; tetrachloromethane; trichloroethylene; and the like), hydrocarbons (xylene; toluene; limonene; isohexane; cyclohexane; and the like), sulfur-based solvents (dimethyl sulfoxide or DMSO; sulfolane; and the like), nitrogenous solvents (1-nitropropane; and the like), dihydrolevoglucosenone or cyrene, and the like. Preferably, the eluent is chosen from ketones, cyclic ketones and cyclic esters, such as MEK, DEK, 4-heptanone, 2,4-dimethyl-3-pentanone, MIBK, cyclopentanone, GBL, GVL, taken alone or as a mixture. Preferentially, the eluent is chosen from DEK, 4-heptanone, 2,4-dimethyl-3-pentanone, GBL and GVL, taken alone or as a mixture. Very preferably, the eluent is of the same chemical nature, indeed even the same solvent, as the dissolution solvent.

Advantageously, stage b) of extraction by size exclusion implements at least one train, preferably a single train, of several fixed beds of a size exclusion solid, in operation. Said train(s) is (are) advantageously fed by the crude polymer solution resulting from stage a) or optionally the clarified polymer solution resulting from the optional stage b′), and by the eluent. When stage b) comprises several, in particular between two and four, trains of fixed beds of size exclusion solid, in operation, these trains of fixed beds operate parallel to one another and are each fed by a fraction of the polymer solution which feeds stage b), in particular the crude polymer solution resulting from stage a) or optionally the clarified polymer solution resulting from the optional stage b′), and by a fraction of the eluent which feeds stage b). In this case, said polymer solution which feeds stage b) is then divided into as many partial streams of crude or optionally clarified polymer solution as of trains of fixed beds in operation, and similarly said eluent which feeds stage b) is then divided into as many partial streams of eluent as of trains of fixed beds in operation.

Optionally, the process may also comprise, in particular parallel to the stage b), at least one train of fixed beds of size exclusion solid (as described below), which is (are) not in operation, in particular which are at standstill and/or in regeneration and/or backup mode.

The (or each) train of fixed beds, advantageously in operation, of stage b) of extraction by size exclusion comprises n fixed beds of a size exclusion solid, n being an integer greater than or equal to 4, preferably of between 4 and 30, preferentially between 8 and 24, very preferentially between 8 and 21 and in a preferred way between 12 and 15. The number of fixed beds must be sufficient, in order to make possible efficient separation, and reasonable, so as to limit the costs, in particular the capital costs. The n fixed beds are in series with respect to one another.

The n fixed beds of size exclusion solid may operate in a closed loop or in an open circuit. Preferably, the n fixed beds of size exclusion solid operate in a closed loop, that is to say that the n fixed beds are connected to one another successively and preferably in a closed loop (the first is connected to the second, the second to the third, and the like, and the nth to the first), thus making possible continuous operation of the extraction by size exclusion and advantageously a reduction in the consumption of eluent, since the eluent is then in part continuously regenerated and recycled.

In one (or each) train of fixed beds, the n fixed beds of size exclusion solid are advantageously distributed in one or more column(s), preferably in M column(s), M being an integer of between 1 and the total number of fixed beds of exclusion solid of the train under consideration, that is to say M being of between 1 and n. Thus, the (or each) train of fixed beds of stage b) of extraction by size exclusion may implement between 1 and n column(s), each comprising one or more fixed beds of size exclusion solid. For example, the (or each) train of fixed beds of stage b) may implement a single column (or tower), preferably of large capacity (volume), which comprises the n fixed beds, or two columns, each of which comprises n/2 fixed beds. These two configurations make it possible to significantly limit the capital costs but require unloading the entire column, i.e. n fixed beds or n/2 fixed beds, when there is a problem with regard to one of the beds of the column. According to another embodiment, the (or each) train of fixed beds of stage b) implements n columns (or towers), preferably each of the columns being of smaller capacity (volume) than in the preceding case, each of the columns comprising a fixed bed of size exclusion solid, thus facilitating the maintenance and/or the cleaning and/or the by-passing in particular of one bed among the n beds in operation since, in this configuration, just one column (which comprises just one bed) has to be unloaded and/or by-passed rather than an assembly of beds. However, the latter configuration generates higher capital costs.

Preferably, the size exclusion solid is provided in the form of solid particles. It may also be referred to as a granular medium. The size exclusion solid is chosen so as to be inert with respect to the polymer solution to be treated, that is to say to the dissolution solvent and to the PVC resins to be treated, and with respect to the eluent. It is also chosen so as to make possible efficient separation of the compounds present, in particular dissolved, in the treated polymer solution, and more particularly efficient separation of the impurities solubilized in the dissolution solvent, with respect to the PVC resins, themselves also dissolved. The size exclusion solid is advantageously a porous (meso-and/or macroporous) solid which may be organic (generally polymeric) and/or inorganic, and preferably having a volume-average pore diameter of preferably between 1 nm and 500 nm, preferentially between 2 nm and 100 nm, very preferentially between 2 nm and 50 nm (mesoporous solid) and in a preferred way between 3 nm and 30 nm. Advantageously, the size exclusion solid comprises silica (such as a silica gel, also referred to as silica, and/or grafted silica, and the like), a carbon molecular sieve, a carbon replica, a polymeric molecular sieve (different in chemical nature from PVC), a porous polymer gel, a preferably dealuminated zeolite (for example of USY type), a preferably calcined alumina, a material of MOF (metal organic framework) type or their mixtures. Preferably, the size exclusion solid comprises, preferably consists of, a silica gel (or silica), a grafted silica, a carbon molecular sieve or their mixtures. Very advantageously, the size exclusion solid preferably exhibits a pore volume of between 0.01 and 3.0 ml/g, preferably between 0.1 and 2.0 ml/g, preferentially between 0.3 and 1.2 ml/g. The average pore diameter and the pore volume of the size exclusion solid are determined by mercury porosimetry and more particularly measured by mercury intrusion porosimetry according to Standard ASTM D4284-83 at a maximum pressure of 4000 bar, using a surface tension of 484 dynes/cm and a contact angle of 140°. The wetting angle which was taken is equal to 140° following the recommendations of the publication “Techniques de l′ingénieur, traité analyse et caractérisation” [Engineering Techniques, Analysis and Characterization Treatise], page 1050, by J. Charpin and B. Rasneur. In order to obtain better preciseness, the given value of the mercury volume in ml/g corresponds to the value of the total mercury volume in ml/g measured on the sample minus the value of the mercury volume in ml/g measured on the same sample for a pressure corresponding to 30 psi (approximately 2 bar). These same parameters, and in particular the volumes and diameter of the solid in the mesoporosity range, may also be measured by nitrogen adsorption/desorption volumetry (also called nitrogen adsorption isotherm), an analysis method complementary to that mentioned above. This analysis corresponds to the physical adsorption of nitrogen molecules in the porosity of the material via a gradual increase in pressure at constant temperature and provides information on the textural characteristics. In particular, it makes it possible to access the mesoporous distribution of the size exclusion solid. Thus, the pore distribution representative of a population of pores centred in a range from 2 to 50 nm is determined by the Barrett-Joyner-Halenda (BJH) model. The nitrogen adsorption-desorption isotherm according to the BJH model is described in the periodical “The Journal of the American Chemical Society”, 73, 373 (1951), written by E. P. Barrett, L. G. Joyner and P. P. Halenda.

The particles of size exclusion solid preferably have a volume-average equivalent diameter (preferably determined by laser particle size analysis, that is to say by laser diffraction using a particle size analyzer) of between 20 and 5000 μm, preferably between 50 and 1500 μm, preferentially between 100 and 800 μm and more preferably still between 300 and 600 μm. Advantageously, the solid particles are substantially spherical.

According to the invention, the (or each) train of fixed beds of stage b) of extraction by size exclusion is fed with crude or optionally clarified polymer solution at at least one point of injection F of the polymer solution and with at least one eluent at a point of injection S of the eluent. Preferably, the train of fixed beds in operation under consideration is fed with crude or optionally clarified polymer solution at a point of injection F of the polymer solution and with an eluent at a point of injection S of the eluent.

Preferably, the eluent and the polymer solution feed the (or each) train of fixed beds of the stage of extraction by size exclusion according to a ratio of the flow rate by volume of the eluent with respect to the flow rate by volume of the polymer solution of between 0.1 and 50.0, preferably between 0.2 and 10.0, preferably between 0.5 and 5.0, preferentially between 0.8 and 2.0, it also being possible to refer to such a ratio as level of solvent. Such a level of solvent, that is to say such an adjustment of the flow rate by volume of the crude or optionally clarified polymer solution and of the flow rate by volume of the eluent, for the (or each) train under consideration, contributes to the efficiency of the separation by size exclusion of the PVC resins and of the impurities present in the polymer solution which feeds the extraction stage b).

When the train of fixed beds comprises several points of injection Fi of the polymer solution, for example two points of injection F1 and F2 of the polymer solution, the stream of the crude or clarified polymer solution which feeds said considered train of fixed beds of the extraction stage is divided into as many partial streams of polymer solution for feeding said train of fixed beds at said injection points F1, said partial streams of polymer solution exhibiting flow rates which are identical to or different from one another.

When the train of fixed beds comprises several points of injection Si of eluent, for example two injection points S1 and S2, the total stream of eluent which feeds said considered train of fixed beds is divided into as many partial streams of eluent (that is to say, into i partial streams of eluent, i being an integer equal to the number of points of injection Si of eluent) for feeding said train of fixed beds at said injection points Si, said partial streams of eluent exhibiting flow rates which are identical to or different from one another.

The (or each) train of fixed beds of stage b) of extraction by size exclusion implements at least one withdrawal of an extract at at least one point of withdrawal E of the extract, and at least one withdrawal of a raffinate at at least one point of withdrawal R of the raffinate. Preferably, the (or each) train of fixed beds of stage b) of extraction by size exclusion implements a withdrawal of an extract at a point of withdrawal E of the extract, and a withdrawal of a raffinate at a point of withdrawal R of the raffinate.

The points of injection F of the polymer solution and S of the eluent and the points of withdrawal E of the extract and R of the raffinate are distinct from one another. They are advantageously located between two consecutive beds, or optionally upstream of the first bed, in particular in the case of an open circuit (in the case of a closed loop of n fixed beds, as the nth bed is connected to the first bed, these two beds are considered as consecutive). However, they may be located, in the case of an embodiment in particular according to a Varicol® process (described below), on average over an operating cycle, in the middle of a fixed bed or in a fixed bed. The points of injection of the polymer solution and of the eluent and the points of withdrawal of the extract and of the raffinate are distributed with respect to one another so that they determine at least three, preferably four, successive main operating zones of the n fixed beds:
a zone I of elution of the impurities, comprised between the point of injection S of the eluent and the point of withdrawal E of the extract;
a zone II of elution of at least one PVC polymer, comprised between the point of withdrawal E of the extract and the point of injection F of the polymer solution;
a zone III of retention of the impurities, comprised between the point of injection F of the polymer solution and the point of withdrawal R of the raffinate; and
optionally, and preferably, a zone IV comprised between the point of withdrawal R of the raffinate and the point of injection S of the eluent.

When there exist several points of injection Fi of the polymer solution and/or Si of the eluent and/or several points of withdrawal of the extract and/or of the raffinate, the zones I, II, III and IV start at the first point of injection and/or of withdrawal of the stream considered (eluent, polymer solution, extract or raffinate), the term “first” being defined here as being that which is the furthest upstream of all of the points of injection and/or of withdrawal of said stream considered. When there exist several points of injection Fi of the polymer solution and/or Si of the eluent and/or several points of withdrawal of the extract and/or of the raffinate, secondary operating zones may also be defined, in particular inside the zones I, II, III and IV, which are the main operating zones.

When the n fixed beds of the train considered of stage b) operate in an open circuit, the eluent is introduced at the point(s) of injection S of the eluent, the crude or optionally clarified polymer solution is introduced at the point(s) of injection F of the polymer solution, the extract is withdrawn at the point(s) of withdrawal E of the extract and all the remainder is withdrawn at the point(s) of withdrawal R of the raffinate. The injection and withdrawal points thus define three successive main operating zones, zones I, II, III. In this embodiment, a large amount of eluent, with respect to the polymer solution, is generally necessary in order to be able to maximize the separation. For example, this mode of operation in an open circuit requires a ratio of the flow rates by volume of the eluent with respect to the polymer solution of between 2.0 and 50.0, preferably between 5.0 and 20.0, indeed even between 5.0 and 10.0.

When the n fixed beds of the train considered of stage b) operate in a closed loop, the eluent is introduced at the point(s) of injection S of the eluent, the crude or optionally clarified polymer solution is introduced at the point(s) of injection F of the polymer solution, an extract is withdrawn at the point(s) of withdrawal E of the extract, a raffinate is withdrawn at the point(s) of withdrawal R of the raffinate and at least a part of the eluent introduced advantageously remains in circulation in the closed loop of the n beds (the expression used is then recycling of the eluent). In this embodiment, the points of injection and of withdrawal then define four successive main operating zones, zones I, II, III and IV, it being possible for zone IV to be called the zone for regeneration and recycling of the eluent. In this particular embodiment, the eluent supply requirements (i.e. the amounts of eluent introduced at S) are very advantageously smaller than in the case of an operating mode of an open circuit in order to ensure efficient separation. For example, this mode of operation in a closed loop requires a ratio of the flow rates by volume of the eluent with respect to the polymer solution of between 0.1 and 10, preferably between 0.2 and 5.0, indeed even between 0.8 and 2.0.

Advantageously, in the case of a closed loop of the n fixed beds, the n beds of size exclusion solid are distributed in the zones I to IV, preferably according to a configuration referred to as being of a/b/c/d type, the distribution of the beds of size exclusion solid in the zones I to IV, with respect to the total number n of beds of size exclusion solid, being such that:
a is the number of beds of size exclusion solid in zone I,
b is the number of beds of size exclusion solid in zone II,
c is the number of beds of size exclusion solid in zone III, and
d is the number of beds of size exclusion solid in zone IV, and wherein:
a=(n*0.30)*(1±0.40, preferably 1±0.30),
b=(n*0.15)*(1±0.40, preferably 1±0.30),
c=(n*0.25)*(1±0.40, preferably 1±0.30), and
d=(n*0.30)*(1±0.40, Preferably 1+0.30).

It is obvious to a person skilled in the art that the sum of the number of fixed beds in the zones I, II, III and IV (i.e. a+b+c+d) is advantageously equal to n, the total number of fixed beds in the considered train of fixed beds in operation. Thus, a 6/3/4/2 configuration means that there are 15 fixed beds of size exclusion solid divided into 6 fixed beds in zone I, 3 fixed beds in zone II, 4 fixed beds in zone III and 2 beds in zone IV.

Very advantageously, the packing density of each of the n fixed beds of size exclusion solid, expressed by weight of size exclusion solid per unit volume of bed (i.e., by kg of solid per m³ of bed) may vary between 100 and 1500 kg/m³, preferably between 300 and 1000 kg/m³, preferentially between 400 and 800 kg/m³.

According to the invention, the points of injection F and S and of withdrawal E and R are shifted over time by one bed of size exclusion solid, according to a frequency determined by a predetermined permutation period. A permutation period may be defined as being the period of time between two successive displacements (or shiftings) by one fixed bed of the injection and withdrawal points. The periodic displacement (or shifting) of the points of injection F and S and of withdrawal E and R may be carried out synchronously or non-synchronously, it being possible for the latter case (non-synchronously) to be known under the name of Varicol®. The periodic displacement of the points of injection and of withdrawal all along the n fixed beds makes it possible in particular to define an operating cycle and also advantageously a cycle time which corresponds to the period of time required for the points of injection and of withdrawal to return to their initial position, that is to say corresponds to the number of beds n multiplied by the permutation period.

When the n fixed beds of exclusion solid operate in a closed loop, an operating cycle thus advantageously comprises as many permutation periods as of beds of size exclusion solid present in the closed separation loop. For example, an operating cycle of a train comprising 12 fixed beds of size exclusion solid comprises 12 permutation periods.

Thus, in the preferred embodiment in which the n fixed beds of exclusion solid of the train considered operate in a closed loop, the permutation period is preferably adjusted so as to define a cycle time, which corresponds to the period of time required for the points of injection and of withdrawal to return to their initial position, of between 1 minute and 600 minutes, preferably between 5 minutes and 200 minutes, in a preferred way between 10 minutes and 90 minutes. Such a cycle time contributes towards the efficiency of the separation by size exclusion of the PVC resins and of the impurities present in the polymer solution which feeds the extraction stage b).

In the case of the embodiment in which the n fixed beds operate in an open circuit (that is to say that everything is withdrawn with the extract and the raffinate), the cycle time may also be of between 1 minute and 600 minutes, preferably between 5 minutes and 200 minutes, in a preferred way between 10 minutes and 90 minutes.

The displacement of the points of injection F and S and of withdrawal E and R may take place by the installation of a series of on-off valves, controlled by an automatic sequence, or also of a single rotary valve.

In general, the liquid flow in the fixed beds is advantageously from the bed i to the bed i+1, i being an integer of between 1 and n, the total number of fixed beds, that is to say from upstream to downstream, being possibly referred to as downward liquid flow, even if the presence of pump(s) is necessary (in particular between the n^{th} bed and the first bed in the case of operation in a closed loop and where the n beds are in a column). At the moment of the permutation (or displacement of the injection and withdrawal points), the feed and withdrawal points are displaced by one bed, placed downstream of the preceding bed, thus creating/simulating a countercurrentwise liquid flow, optionally referred to as upward liquid flow. A stop flow rate may then be defined when the two countercurrentwise liquid flow rates are equal, that is to say when the downward liquid flow rate is equal to the upward liquid flow rate. This stop flow rate may be calculated by dividing the intergranular volume of the size exclusion solid in the beds by the permutation period, the intergranular volume of the size exclusion solid in the beds being a function of the packing density of the fixed beds of size exclusion solid and of the density of the particles of size exclusion solid. More particularly, the intergranular volume (V_{(intergranular)}) of the size exclusion solid may be calculated by the following formula:

V_{(intergranular)}=V_{(beds)}×(1−d_{(packing)}/d_{(grain)}+V_{dead}

with:

V_{(intergranular)}: the intergranular volume of the size exclusion solid in the beds (in m³);

V_{(beds)}: the geometric volume of the beds (in m³);

d_{(packing)}: the packing density of the size exclusion solid in the beds (in kg/m³), corresponding to the true packing density of the size exclusion solid, that is to say to the weight of said size exclusion solid per unit volume of the bed. As a first approach, it may be likened to the tapped packing density, which consists of the weight of solid which occupies a given volume after tapping said solid by vibration, according to a principle derived from Standards D4164 and D4180 applied to the case of catalysts;

d_{(grain)}: the grain density of the size exclusion solid, typically measured by mercury porosimetry (in kg/m³);

V_{dead}: the volume (in m³) of the equipment without size exclusion solid but through which the fluid concerned flows, in particular the polymer solution (for example, the volume of the lines upstream, downstream, and the like).

The stop flow rate, which is a flow rate by volume, makes it possible to calculate dimensionless parameters, in particular relating to the zones II and IV, in particular the ratio of the flow rate by volume in the zone Il to the stop flow rate, and the ratio of the flow rate by volume in the zone IV to the stop flow rate. Preferably, the ratio of the flow rate by volume of the zone IV divided by the stop flow rate is less than or equal to 2, preferentially of between 0.5 and 1.5 and more preferably still between 0.8 and 1.0. Preferably, the ratio of the flow rate by volume of the zone II divided by the stop flow rate is of between 0.5 and 3.0, preferentially between 0.9 and 1.5 and preferably between 1.0 and 1.25. Thus, the stop flow rate makes it possible to contribute to the adjustments of the extraction stage b) and thus to the efficiency of the separation.

Moreover, very advantageously, the superficial velocity in the fixed beds of an operating zone, which corresponds to the flow rate by volume in the zone considered divided by the cross section of said zone (i.e., of the column in which the beds of said zone considered are located) may be adjusted so that this surface velocity is of between 0.01 and 10.0 cm/s and preferentially between 0.05 and 2.5 cm/s. The adjustment of the superficial velocity in the fixed beds advantageously makes it possible in particular to control the attrition of the particles of size exclusion solid and thus to adjust the operation of the train of fixed beds of the extraction stage so as to avoid large pressure drops (in particular encountered at high velocity) and/or dispersion problems (in particular encountered at low velocity).

Preferably, the stage of extraction by size exclusion of stage b) is carried out at a temperature of between room temperature and 200 °C, preferably between 20 °C and 200°C, preferably of between 40 °C and 180 °C, more preferably of between 60 °C and 150 °C, and advantageously at a pressure of between atmospheric pressure and 11.0 MPa absolute, preferably between 0.1 MPa and 11.0 MPa absolute, preferably between 0.1 MPa and 5.0 MPa absolute, more preferably between 0.1 MPa and 2.0 MPa absolute. Under these operating conditions, the PVC resins are dissolved in the dissolution solvent and optionally in the eluent, the latter (i.e. the dissolution solvent and the eluent) for their part being at least in part in liquid form. Preferably, the temperature and pressure conditions of stage b) are the same as those of the dissolution stage a).

Stage b) of extraction by size exclusion thus makes it possible to recover at least one extract which comprises, at least in part, preferably completely, the impurities present in the polymer solution which feeds said stage b) and at least one raffinate which comprises a polymer solution freed, at least in part, preferably completely, of impurities. Said raffinate recovered at the end of the stage of extraction by size exclusion constitutes, at least in part, preferably completely, the purified polymer solution. This purified polymer solution is subsequently preferably sent, at least in part, preferably completely, to stage c) of polymer-solvent separation. However, if necessary, it may be sent to other optional purification stages, so as to optimize, if need be, the purification of the targeted PVC resins. This stage of extraction by size exclusion thus makes it possible to efficiently and continuously separate the impurities, in particular soluble impurities, from the crude or optionally clarified polymer solution comprising the PVC resin(s) dissolved in the dissolution solvent.

The extraction by size exclusion, in particular in the case of a closed loop of the fixed beds, makes it possible to efficiently separate the impurities from the PVC polymers, according to a continuous mode, which makes it possible to limit the labour required to operate said stage while making it easier to operate. It also allows high productivity, in particular compared with size exclusion chromatography operations in batch mode, while providing a relatively low consumption of eluent.

### Stage C) of Polymer-Solvent Separation

According to the invention, the process comprises a stage c) of polymer-solvent separation of the purified polymer solution, in order to obtain at least one stream of at least one purified PVC polymer and at least one fraction of at least one solvent comprising the dissolution solvent.

Stage c) of polymer-solvent separation advantageously implements at least one solvent recovery section and preferably between one and five solvent recovery section(s).

Advantageously, stage c) is fed by the purified polymer solution obtained at the end of stage b) or optionally a final purified polymer solution resulting from an additional purification stage located downstream of stage b) of extraction by size exclusion.

Stage c) of polymer-solvent separation is thus primarily targeted at separating, at least in part, preferably predominantly, the dissolution solvent and optionally the eluent from the PVC polymer(s) contained in the polymer solution which feeds stage c), more particularly the purified polymer solution or optionally a final purified polymer solution resulting from an additional purification stage, so as to recover at least one PVC polymer, freed at least in part, preferably predominantly and preferentially completely, of the dissolution solvent, and optionally of the eluent, which are still present in the polymer solution which feeds stage c). The term “predominantly” should be understood as meaning the removal of at least 50% by weight, preferentially at least 70% by weight, in a preferred way at least 90% by weight, more preferably at least 95% by weight, very preferentially at least 99% by weight, indeed even at least 99.9% by weight, of the solvent(s) (i.e. dissolution solvent and optionally eluent) contained in the purified polymer solution, with respect to the weight of the solvent(s) contained in the purified polymer solution which feeds stage c), in particular the dissolution solvent and optionally the eluent which is (are) contained in said purified polymer solution. Any method of solvent(s)/polymer(s) separation known to a person skilled in the art may be carried out, in particular any method making possible a change in phase of the polymer(s) and/or solvent(s). The solvent(s) may be separated, for example, by precipitation or crystallization of the polymers, evaporation of the solvents, flash devolatilization, atomization (high pressure jet, rotary atomizer, dual fluid nozzle, ultrasonic atomizer), stripping, phase separation, extrusion, density difference and in particular separation by settling or centrifugation, and the like.

The stream of at least one purified PVC polymer thus obtained may correspond to a concentrated polymer solution or to at least one purified PVC resin in solid form. Preferably, stage c) of polymer-solvent separation additionally comprises a conditioning section for conditioning at least one purified PVC resin in solid form and more particularly in the form of a powder, beads or granules.

Stage c) of polymer-solvent separation is also targeted at recovering, at least in part, preferably predominantly and preferentially completely, the solvent(s) contained in the purified polymer solution which feeds stage c), in particular the dissolution solvent and optionally the eluent. Stage c) of polymer-solvent separation is also optionally targeted at purifying and recycling the recovered solvent fraction, in particular upstream of the dissolution stage a). The term “predominantly” should be understood as meaning at least 50% by weight, preferentially at least 70% by weight, more preferably at least 90% by weight and more preferably still at least 95% by weight, with respect to the weight of the solvent(s) contained in the purified polymer solution which feeds stage c).

Advantageously, stage c) of polymer-solvent separation implements at least one solvent recovery section, the latter preferably comprising equipment operated at different temperatures and different pressures, for the purpose of obtaining at least one solvent fraction and one purified polymer fraction.

Thus, the process according to the invention makes it possible to efficiently and continuously recover the PVC polymers from a plastic feedstock, with a high productivity and a limited number of operations. Very advantageously, the process according to the invention makes it possible to obtain a PVC polymer stream exhibiting a high purity, preferably of greater than or equal to 90%, preferably of greater than or equal to 95%, preferentially of greater than or equal to 99% and more preferably still of strictly greater than 99.9% (by weight of PVC polymer, with respect to the total weight of the purified stream recovered), starting from any type of PVC-based plastic feedstock. Another advantage of the process according to the invention also lies in the fact that an efficient separation of the impurities, in particular of the additives, present in the plastic feedstock is possible, while making possible a reasonable consumption of solvents, in particular of dissolution solvent and of eluent, and a lower energy consumption than that required for more conventional “thermal” separations, for example crystallization. The process according to the invention thus makes it possible to obtain a stream of purified PVC polymer which is less coloured than the plastic feedstock be treated, indeed even colourless, and very advantageously deodourized. More particularly, the process according to the invention makes it possible to obtain a stream of purified PVC polymer freed of at least a part, preferably all, of the impurities, such as the additives, present in the plastic feedstock and freed, at least in part, indeed even completely, of solvent, in particular of the dissolution solvent and of the eluent. Thus, the process according to the invention advantageously makes it possible to obtain a stream of purified PVC polymer comprising a content of solvent, in particular of dissolution solvent or of eluent, of less than or equal to 10% by weight, preferably of less than or equal to 5% by weight, preferentially of less than or equal to 1.0% by weight and more preferably still of less than or equal to 0.1% by weight, and very advantageously a content of impurities of less than or equal to 10% by weight, preferably of less than or equal to 5% by weight and preferentially of less than or equal to 1.0% by weight, more preferably still of less than or equal to 0.5% by weight, indeed even of less than or equal to 0.1% by weight, the percentages being given with respect to the total weight of the stream of purified PVC polymer. In particular, the stream of purified PVC polymer obtained very advantageously exhibits contents:
of less than 0.1% by weight of phthalates subject to authorization by the REACH regulation in Europe (Annex XIV of Regulation (EC) No. 1907/2006 of the European Parliament and of the Council of 18 December 2006), in particular strictly of less than 0.1% by weight of phthalates chosen from the list consisting of the following phthalates: dibutyl phthalate (DBP), dioctyl phthalate or diethylhexyl phthalate (DOP or DEHP), benzyl butyl phthalate (BBP), dibutyl phthalate (DBP), diisobutyl phthalate (DIBP), dipentyl phthalate (DPP), diisopentyl phthalate, isopentyl n-pentyl phthalate, dihexyl phthalate, bis(2-methoxyethyl) phthalate, alone or as a mixture,
of less than 0.1% by weight of the element lead, in particular of said lead contained in additives of the metal stabilizers type evaluated in the context of the REACH regulation and subject to restrictions (Annex XV) described in detail and adopted between December 2017 and March 2018 by the Risk Assessment Committee (RAC) and the Socio-Economic Analysis Committee (SEAC) of the ECHA,
of less than 0.1% by weight, and preferably of less than 0.01% by weight, of the element cadmium, in particular of said cadmium contained in additives of the metal stabilizers type prohibited by the REACH regulation according to the amendment of Annex XVII (Regulation 494/2011 of 20 May 2011).

### Device for Extraction by Size Exclusion

The present invention also relates to a device for extraction by size exclusion suitable for separating PVC polymers from impurities comprised in a polymer solution. The device comprises:
n fixed beds of a size exclusion solid, n being an integer greater than or equal to 4, preferably of between 4 and 30, preferentially between 8 and 24, very preferentially between 8 and 21 and in a preferred way between 12 and 15, said size exclusion solid having a volume-average pore diameter of preferably between 1 nm and 500 nm, preferably between 2 nm and 100 nm, preferentially between 2 nm and 50 nm, preferentially between 3 nm and 30 nm, and in a preferred way being a silica gel, a grafted silica, a carbon molecular sieve or their mixtures,
   the n fixed beds of the size exclusion solid being distributed in one or more column(s), preferably in M column(s), M being an integer of between 1 and the total number n of fixed beds of the exclusion solid, the n beds being connected in series and preferably in a closed loop,
N systems of injection, preferably distinct from one another, for the polymer solution, N systems of injection, preferably distinct from one another, for an eluent, N systems of withdrawal, preferably distinct from one another, for an extract and N systems of withdrawal, preferably distinct from one another, for a raffinate, N being an integer preferably equal to n, said injection and withdrawal systems being located between two consecutive beds or optionally upstream of the first bed,
   wherein the systems for injection of the polymer solution and of the eluent and/or the systems for withdrawal of the extract and of the raffinate which are located at one and the same position, that is to say between the two actual consecutive beds or optionally upstream of the first bed, are distinct or identical (the term “identical” should be understood as meaning that a system of valves may make possible either the introduction of the polymer solution or that of the eluent, or the withdrawal of one or the other stream, i.e. of the extract or of the raffinate),
each injection and withdrawal system comprising at least one valve suitable for allowing or not allowing the passage of a stream of polymer solution and/or of eluent and/or of extract and/or of raffinate, preferably i) a series of on-off valves which are controlled by an automatic sequence, or ii) a single rotary valve, so as:
to define, at an instant t, a point of injection of the polymer solution, a point of injection of the eluent, a point of withdrawal of the extract and a point of withdrawal of the raffinate, said points of injection and of withdrawal being distinct from one another and determining at least three, preferably four, successive main zones of operation of the n fixed beds:
a zone I of elution of the impurities, comprised between a point of injection of the eluent and a point of withdrawal of the extract;
a zone II of elution of at least one PVC polymer, comprised between the point of withdrawal of the extract and a point of injection of the polymer solution;
a zone III of retention of the impurities, comprised between the point of injection of the polymer solution and a point of withdrawal of the raffinate; and
optionally a zone IV, comprised between the point of withdrawal of the raffinate and the point of injection of the eluent;
and to make possible, over time, a shifting in the points of injection and of withdrawal, synchronously or non-synchronously, according to a frequency determined by a predetermined permutation period, by one fixed bed of size exclusion solid per permutation period.

### Device for Treatment of a Plastic Feedstock

Such a device for extraction by size exclusion may be incorporated in a more encompassing device for treatment of a plastic feedstock in order to obtain a stream of purified PVC polymer, which comprises:
dissolution means for bringing the plastic feedstock and a dissolution solvent into contact so as to dissolve, at least in part, said plastic feedstock in said dissolution solvent, said dissolution means being any type of equipment for bringing the plastic feedstock into contact with and dissolving same in a dissolution solvent, and to obtain a crude polymer solution;
optionally solid-liquid separation means, in particular optionally any type of equipment for solid-liquid separation, suitable for separating insoluble materials in suspension in the crude polymer solution;
at least one device for extraction by size exclusion according to the invention and as described above, advantageously connected to said dissolution means for bringing into contact and dissolving or optionally to at least one of said solid-liquid separation means;
means for separation of the dissolution solvent and optionally of the eluent from a stream of purified PVC polymer, in particular optionally any type of equipment for separating the dissolution solvent and optionally the eluent from a stream of purified PVC polymer, which are advantageously connected to said at least one device for extraction by size exclusion.

Said device for treatment of a PVC feedstock in order to obtain a stream of purified PVC polymer also advantageously comprises means for transportation between said means and devices.

Such a device very advantageously makes it possible to recover the PVC polymers with a high purity from a PVC-based plastic feedstock which may comprise a multitude of impurities.

The example which follows and the figures illustrate the invention, notably particular embodiments of the invention, without limiting the scope thereof.

EXAMPLES

### Example 1

This example is the result of digital simulations carried out on the basis of experiments performed in the laboratory.

The feedstock to be treated is composed of a poly(vinyl chloride) or PVC resin (55% by weight) with a molar mass MW=120 000 g/mol and of a didecyl phthalate (DiDP) additive (45% by weight), the percentages being given by weight with respect to the total weight of the feedstock.

The feedstock is first dissolved in diethyl ketone (DEK) at 100 °C, at atmospheric pressure, to form a homogeneous crude polymer solution comprising 80% by weight of DEK and 20% by weight of feedstock (polymer and additive).

The crude polymer solution obtained is introduced into a simulated moving bed, comprising 15 fixed beds of a solid consisting of silica gel. Said fixed beds are distributed following a 6/3/4/2 configuration (cf. FIG. 1). The eluent is diethyl ketone (DEK).

The silica gel exhibits the following properties:
bead diameter=500 μm;
pore diameter=6-10 nm;
pore volume=0.50 ml/g of solid;
packing density=530 kg of solid/m³ of bed.

Each bed is modelled by a 1D fixed piston bed model with axial dispersion and a Fick model for intragranular transfer. As the radius of gyration of the PVC is estimated at 39 nm, the polymer is considered as being only present in the extragranular phase. The additives and the solvent have a radius of gyration of less than 1 nm and can thus diffuse into the intragranular porosity. The medium in the beds is considered isothermal (100 °C) and the density of the polymer solution is considered constant (800 kg/m³).

The extraction is adjusted with the following settings:
cycle time=15 min, i.e. a permutation period of 60 seconds;
flow rate by volume of eluent with respect to the flow rate by volume of polymer solution S/F=1.32;
Zone IV flow rate/stop flow rate=0.97;
Zone II flow rate/stop flow rate=1.05;
maximum superficial velocity=1.43 cm/s.

The concentration profiles obtained for the PVC and the additive, by simulation, are illustrated in FIG. 3, which shows the concentration profile of the PVC (solid line) and that of the DiDP (dotted line). By convention, the injection of the eluent is carried out just upstream of the bed 1. The concentrations along the entire length of the bed are given as percentages by weight of the compound followed, that is to say of the PVC or of the additive, with respect to the weight of DEK.

From FIG. 3, it is apparent that the PVC, which does not explore the intragranular porosity, is entrained towards the raffinate and withdrawn between the beds 13 and 14. As the additive DiDP is smaller, it diffuses into the intragranular porosity and is entrained towards the extract with a withdrawal between the beds 6 and 7.

The extraction carried out in a simulated moving bed makes it possible to obtain the following performance qualities:
purity of the separated PVC=99.93% by weight (which corresponds to the weight, or flow rate by weight, of PVC in the raffinate with respect to the total weight, or total flow rate by weight, of the PVC and additive combination in the raffinate, excluding the solvent DEK);
yield of the separated PVC=99.95% (which corresponds to the flow rate by weight of withdrawn PVC in the raffinate divided by the flow rate by weight of withdrawn PVC in the extract+raffinate combination);
productivity=149 Kg of Withdrawn PVC in the Raffinate/h/m³ of Bed.

The raffinate at the outlet of the simulated moving bed for extraction by size exclusion may then be recovered and sent into a polymer-solvent separation section, in particular a section for evaporation of the solvent DEK.

1. A process for the recovery of a stream of at least one purified PVC polymer from a plastic feedstock, comprising:
a) a dissolution stage comprising bringing the plastic feedstock into contact with a dissolution solvent, in order to obtain at least one crude polymer solution;
b′) optionally a stage of separation of the insoluble materials from the crude polymer solution obtained at the end of stage a), in order to obtain at least one clarified polymer solution;
b) a stage of extraction by size exclusion of the crude polymer solution obtained at the end of stage a) or optionally of the clarified polymer solution obtained at the end of stage b′), in order to obtain a purified polymer solution,
wherein said stage of extraction by size exclusion implements at least one train of n fixed beds of a size exclusion solid, n being an integer greater than or equal to 4, the n fixed beds of the size exclusion solid being in series,
said train of fixed beds of stage b) being fed with crude or optionally clarified polymer solution at at least one point of injection F of the polymer solution and with an eluent at at least one point of injection S of the eluent,
wherein said train of fixed beds of stage b) implements at least one withdrawal of an extract at at least one point of withdrawal E of the extract, and at least one withdrawal of a raffinate at at least one point of withdrawal R of the raffinate,
wherein the points of injection of the polymer solution and of the eluent and the points of withdrawal of the extract and of the raffinate are distinct from one another and distributed so that they determine at least three successive main zones of operation of the n fixed beds:
a zone I of elution of the impurities, located between the point of injection of the eluent and the point of withdrawal of the extract;
a zone II of elution of at least one PVC polymer, located between the point of withdrawal of the extract and the point of injection of the polymer solution;
a zone III of retention of the impurities, located between the point of injection of the polymer solution and the point of withdrawal of the raffinate; and
optionally a zone IV, located between the point of withdrawal of the raffinate and the point of injection of the eluent,
wherein the points of injection and of withdrawal are shifted over time by one fixed bed of size exclusion solid according to a frequency determined by a predetermined permutation period,
wherein the raffinate is recovered in order to constitute, at least in part, the purified polymer solution, and
c) a solvent-polymer separation stage, for separating the purified polymer solution into a stream of purified PVC polymer and at least one solvent fraction comprising dissolution solvent.

2. The process according to claim 1, wherein the dissolution solvent is an organic solvent chosen from ketones, amides, esters, ethers, chlorinated solvents, sulfur-based solvents, nitrogenous solvents, hydrocarbons and their mixtures.

3. The process according to claim 1, or wherein the eluent is an organic solvent of the same chemical nature as the dissolution solvent.

4. The process according to claim 1, wherein stage b) of extraction by size exclusion implements at least one train of n fixed beds of a size exclusion solid, n being an integer of between 4 and 30.

5. The process according to claim 1, wherein the size exclusion solid is a porous solid having a volume-average pore diameter of between 1 nm and 500 nm.

6. The process according to claim 1, wherein the size exclusion solid comprises a silica gel, a grafted silica, a carbon molecular sieve or their mixtures.

7. The process according to claim 1, wherein the eluent and the polymer solution feed stage b) according to a ratio of the flow rate by volume of the eluent with respect to the flow rate by volume of the polymer solution of between 0.1 and 50.0.

8. The process according to claim 1, wherein the points of injection of the polymer solution and of the eluent and the points of withdrawal of the extract and of the raffinate are located between two consecutive beds or optionally upstream of the first bed.

9. The process according to claim 1, wherein the n beds of size exclusion solid operate in a closed loop and are distributed in four main operating zones, the zones I to IV, according to a configuration referred to as being of a/b/c/d type, the distribution of the beds of size exclusion solid in the zones I to IV, with respect to the total number n of beds of size exclusion solid, being such that:
a is the number of beds of size exclusion solid in zone I,
b is the number of beds of size exclusion solid in zone II,
c is the number of beds of size exclusion solid in zone III, and
d is the number of beds of size exclusion solid in zone IV,
and wherein:
a=(n*0.30)*(1±0.40, preferably 1±0.30),
b=(n*0.15)*(1±0.40,
c=(n*0.25)*(1±0.40, and
d=(n*0.30)*(1+0.40,

10. The process according to claim 1, wherein the n beds are in a closed loop and the permutation period is adjusted so as to define a cycle time, which corresponds to the period of time required for the points of injection and of withdrawal to return to their initial position, of between 1 minute and 600 minutes.

11. The process according to claim 1, wherein stage a) is carried out at a dissolution temperature between 20 °C and 200 °C, 150 °C, and a dissolution pressure between 0.1 and 11.0 MPa absolute, MPa absolute.

12. The process according to claim 1, wherein the amount by weight of PVC polymer of the plastic feedstock which feeds stage a) represents between 2% and 30% by weight with respect to the weight of the dissolution solvent.

13. The process according to claim 1, in which stage b) is carried out at a temperature between 20 °C and 200 °C, and a pressure between 0.1 and 11.0 MPa absolute.

14. A device for extraction by size exclusion of PVC polymer from a polymer solution, said device comprising:
n fixed beds of a size exclusion solid, n being an integer greater than or equal to 4, said size exclusion solid having a volume-average pore diameter of between 1 and 500 nm, and said size exclusion solid being a silica gel, a grafted silica, a carbon molecular sieve or their mixtures,
the n fixed beds of the size exclusion solid being distributed in one or more column(s), the n beds being connected in series,
N systems for injection of the polymer solution, N systems for injection of an eluent, N systems for withdrawal of an extract and N systems for withdrawal of a raffinate, N being an integer, said injection and withdrawal systems being located between two consecutive beds or optionally upstream of the first bed,
wherein the systems for injection of the polymer solution and of the eluent and/or the systems for withdrawal of the extract and of the raffinate which are located at one and the same position are distinct or identical,
each injection and withdrawal system comprising valves suitable for allowing or not allowing the passage of a stream of polymer solution and/or of eluent and/or of extract and/or of raffinate, so as:
to define, at an instant t, a point of injection of the polymer solution, a point of injection of the eluent, a point of withdrawal of the extract and a point of withdrawal of the raffinate, said points of injection and of withdrawal being distinct from one another and determining at least three successive main zones of operation of the n fixed beds:
a zone I of elution of the impurities, comprised between a point of injection of the eluent and a point of withdrawal of the extract;
a zone II of elution of at least one PVC polymer, comprised between the point of withdrawal of the extract and a point of injection of the polymer solution;
a zone III of retention of the impurities, comprised between the point of injection of the polymer solution and a point of withdrawal of the raffinate; and
optionally a zone IV, comprised between the point of withdrawal of the raffinate and the point of injection of the eluent,
and to make possible, over time, a shifting in the points of injection and of withdrawal, synchronously or non-synchronously, according to a frequency determined by a predetermined permutation period, by one fixed bed of size exclusion solid per permutation period.

15. A device for treatment of a plastic feedstock in order to obtain a stream of purified PVC polymer, comprising:
dissolution means for bringing the plastic feedstock and a dissolution solvent into contact, so as to dissolve at least in part said plastic feedstock in said dissolution solvent and to obtain a crude polymer solution;
optionally solid-liquid separation means suitable for separating insoluble materials in suspension in the crude polymer solution;
at least one device for extraction by size exclusion according to claim 14;
means for separation of the dissolution solvent and optionally of the eluent from a stream of purified PVC polymer.

16. The process according to claim 1, wherein the dissolution solvent is an organic solvent chosen from methyl ethyl ketone, diethyl ketone, 4-heptanone, 2,4-dimethyl-3-pentanone, methyl isobutyl ketone, cyclopentanone, cyclohexanone, N,N-diethylformamide, 2-pyrrolidone, N-methyl-2-pyrrolidone, γ-butyrolactone, γ-valerolactone, methoxycyclopentane, tetrahydrofuran, dichloromethane, dimethyl sulfoxide, xylene, isohexane, dihydrolevoglucosenone or cyrene, and their mixtures.

17. The process according to claim 1, wherein stage b) of extraction by size exclusion implements at least one train of n fixed beds of a size exclusion solid, n being an integer of between 12 and 15.

18. The process according to claim 1, wherein the size exclusion solid is a porous solid having a volume-average pore diameter of between 2 nm and 100 nm.

19. The process according to claim 1, wherein the eluent and the polymer solution feed stage b) according to a ratio of the flow rate by volume of the eluent with respect to the flow rate by volume of the polymer solution of between 0.2 and 10.0.

20. The process according to claim 1, wherein the n beds of size exclusion solid operate in a closed loop and are distributed in four main operating zones, the zones I to IV, according to a configuration referred to as being of a/b/c/d type, the distribution of the beds of size exclusion solid in the zones I to IV, with respect to the total number n of beds of size exclusion solid, being such that:
a is the number of beds of size exclusion solid in zone I,
b is the number of beds of size exclusion solid in zone II,
c is the number of beds of size exclusion solid in zone III, and
d is the number of beds of size exclusion solid in zone IV,
and wherein:
a=(n*0.30)*(1±0.30),
b=(n*0.15)*(1±0.30),
c=(n*0.25)*(1±0.30), and
d=(n*0.30)*(1±0.30).
